(19) United States
(12) Patent Application Publication
(10) Pub. No.: US 2026/0003693 A1
(43) Pub. Date: Jan. 1, 2026

(54) SYSTEM AND METHOD FOR PROVIDING COMPUTE EXCHANGE NETWORKED SERVICES

(71) Applicant: Symmetric Research, New York, NY (US)

(72) Inventors: David WENDER, New York, NY (US); Jesper KRISTENSEN, New York, NY (US); Carl ANTHONY, London (GB)

(73) Assignee: Symmetric Research, New York, NY (US)

(21) Appl. No.: 19/251,123

(22) Filed: Jun. 26, 2025

Related U.S. Application Data
(60) Provisional application No. 63/664,394, filed on Jun. 26, 2024.

(51) Int. Cl. G06F 9/50; G06F 11/34

(52) U.S. Cl. CPC G06F 9/5044; G06F 9/5072; G06F 11/3428; G06F 2209/5013

(57) ABSTRACT

A system and method for provisioning abstracted compute resources from cloud computing environments is presented. The method includes detecting in a cloud computing environment a plurality of compute resources, each compute resource based on a processing circuitry and including a resource type; applying a benchmark test to each resource type to generate a benchmark result; determining for each resource type an abstracted compute value based on the benchmark result; receiving a request to provision a compute resource, the request including a value of abstracted compute; and provisioning the compute resource based on the received request.

### CROSS-REFERENCE TO RELATED APPLICATIONS

This application claims the benefit of Provisional Application No. 63/664,394, filed Jun. 26, 2024, the contents of which are hereby incorporated by reference.

### TECHNICAL FIELD

The present disclosure relates generally to provisioning compute services, and specifically to provisioning compute services through a networked exchange.

### BACKGROUND

In today's rapidly evolving digital landscape, the demand for computational resources has escalated exponentially, driven by advancements in fields such as artificial intelligence, big data analytics, and complex scientific simulations. This surge has highlighted a significant challenge: the need for accessible and scalable compute power.

The demand for computational resources, particularly GPUs, has surged dramatically due to advancements in AI and machine learning. This increased demand has resulted in a significant supply crunch, making computational power both expensive and difficult to access for many startups and independent developers. The concept that “compute is the new oil” encapsulates this paradigm shift, highlighting the critical role that computational resources play in driving technological innovation and economic growth.

The AI sector has experienced unprecedented growth, with substantial investments highlighting the significant economic potential and demand for computational resources. As AI adoption continues to accelerate, the need for scalable and efficient compute resource management becomes ever more critical. While individual cloud computing platforms offer some form of orchestration and resource provisioning, such are still riddled with inefficiencies due to dynamic supply and demand which are further governed by available network bandwidth, varying pricing schemes, etc.

What is more, research indicates that the computational requirements for leading-edge AI systems, for example, have been doubling approximately every three to four months. Such growth rates substantially outpace Moore's Law, emphasizing the urgent need for innovative solutions in resource provisioning and management.

Current projections indicate that the demand for compute power will continue to grow exponentially, driven by the increasing complexity of AI models and the widespread adoption of data-intensive applications. According to Shoal Research, the demand for computational resources, particularly GPUs, has surged, causing a supply crunch and making it expensive and difficult for startups and independent developers to access necessary resources. This surge underscores the critical need for innovative solutions to efficiently manage and distribute these resources, ensuring that technological innovation is not hindered by resource constraints.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include detecting in a cloud computing environment a plurality of compute resources, each compute resource based on a processing circuitry and including a resource type. The method may also include applying a benchmark test to each resource type to generate a benchmark result. The method may furthermore include determining for each resource type an abstracted compute value based on the benchmark result. The method may in addition include receiving a request to provision a compute resource, the request including a value of abstracted compute. The method may moreover include provisioning the compute resource based on the request received. Other embodiments of this aspect include corresponding computer systems, apparatus, and computer programs recorded on one or more computer storage devices, each configured to perform the actions of the methods.

Implementations may include one or more of the following features. The method may include: periodically receiving requests to provision compute resources; determining for each received request a value of abstracted compute; and provisioning a compute resource based on each determined value of abstracted compute. The method may include: determining a risk factor associated with the request; and modifying the value of abstracted compute based on the determined risk factor. The method may include: denying the request to provision compute resources based on the risk factor exceeding a predetermined value. The method may include: generating a resource pool of abstracted compute, where the resource pool includes a plurality of identifiers, each identifier correspond to a provisionable resource. The method may include: generating a transaction based on the received request; and storing the generated transaction as a record on a blockchain. The method may include: generating a new benchmark test; applying the new benchmark test to each resource to generate a new benchmark result; determining for each resource type a new abstracted compute value based on the new benchmark result; and provisioning the compute resource based on the new benchmark result. Implementations of the described techniques may include hardware, a method or process, or a computer tangible medium.

In one general aspect, the method may include receiving a request from a client device to allocate compute resources based on a standardized compute framework. The method may also include applying a risk assessment on the request to generate a risk score. The method may furthermore include detecting a plurality of provisionable compute resources of a compute provider corresponding to the received request. The method may in addition include generating a smart contract on a blockchain between the client device and the compute provider, in response to determining that the generated risk score is below a predetermined threshold value. The method may moreover include executing the smart contract by allocating the provisionable compute resources to the client device. Other embodiments of this aspect include corresponding computer systems, apparatus, and computer programs recorded on one or more computer storage devices, each configured to perform the actions of the methods.

Implementations may include one or more of the following features. The method may include: receiving from each compute provider of a plurality of compute providers an allocation of compute resources to a resource pool; executing the smart contract by allocating at least a portion of the compute resource from the resource pool in response to detecting that the compute provider has not provisioned the provisionable compute resources. Implementations of the described techniques may include hardware, a method or process, or a computer-tangible medium.

In one general aspect, a non-transitory computer-readable medium may include one or more instructions that, when executed by one or more processing circuitries of a device, cause the device to: detect in a cloud computing environment a plurality of compute resources, each compute resource based on a processing circuitry and including a resource type; apply a benchmark test to each resource type to generate a benchmark result; determine for each resource type an abstracted compute value based on the benchmark result; receive a request to provision a compute resource, the request including a value of abstracted compute; and provision the compute resource based on the received request. Other embodiments of this aspect include corresponding computer systems, apparatus, and computer programs recorded on one or more computer storage devices, each configured to perform the actions of the methods.

In one general aspect, a system may include a processing circuitry. The system may also include a memory, the memory containing instructions that, when executed by the processing circuitry, configure the system to: detect in a cloud computing environment a plurality of compute resources, each compute resource based on a processing circuitry and including a resource type. The system may in addition apply a benchmark test to each resource type to generate a benchmark result. The system may moreover determine for each resource type an abstracted compute value based on the benchmark result. The system may also receive a request to provision a compute resource, the request including a value of abstracted compute. The system may furthermore provision the compute resource based on the received request. Other embodiments of this aspect include corresponding computer systems, apparatus, and computer programs recorded on one or more computer storage devices, each configured to perform the actions of the methods.

Implementations may include one or more of the following features. The system where the memory contains further instructions which when executed by the processing circuitry further configure the system to: periodically receive requests to provision compute resources; determine for each received request a value of abstracted compute; and provision a compute resource based on each determined value of abstracted compute. The system where the memory contains further instructions which when executed by the processing circuitry further configure the system to: determine a risk factor associated with the request; and modify the value of abstracted compute based on the determined risk factor. The system where the memory contains further instructions which when executed by the processing circuitry further configure the system to: deny the request to provision compute resources based on the risk factor exceeding a predetermined value. The system where the memory contains further instructions which when executed by the processing circuitry further configure the system to: generate a resource pool of abstracted compute, where the resource pool includes a plurality of identifiers, each identifier corresponding to a provisionable resource. The system where the memory contains further instructions which when executed by the processing circuitry further configure the system to: generate a transaction based on the received request; and store the generated transaction as a record on a blockchain. The system where the memory contains further instructions which when executed by the processing circuitry further configure the system to: generate a new benchmark test; apply the new benchmark test to each resource to generate a new benchmark result; determine for each resource type a new abstracted compute value based on the new benchmark result; and provision the compute resource based on the new benchmark result. Implementations of the described techniques may include hardware, a method or process, or a computer tangible medium.

In one general aspect, system may include a processing circuitry. The system may also include a memory, the memory containing instructions that, when executed by the processing circuitry, configure the system to: receive a request from a client device to allocate compute resources based on a standardized compute framework. The system may in addition apply a risk assessment on the request to generate a risk score. The system may moreover detect a plurality of provisionable compute resources of a compute provider corresponding to the received request. The system may also generate a smart contract on a blockchain between the client device and the compute provider, in response to determining that the generated risk score is below a predetermined threshold value. The system may furthermore execute the smart contract by allocating the provisionable compute resources to the client device. Other embodiments of this aspect include corresponding computer systems, apparatus, and computer programs recorded on one or more computer storage devices, each configured to perform the actions of the methods.

Implementations may include one or more of the following features. The system where the memory contains further instructions which when executed by the processing circuitry further configure the system to: receive from each compute provider of a plurality of compute providers an allocation of compute resources to a resource pool; and execute the smart contract by allocating at least a portion of the compute resource from the resource pool in response to detecting that the compute provider has not provisioned compute resources. Implementations of the described techniques may include hardware, a method or process, or a computer-tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example of a network diagram for providing commodification, abstraction, and provisioning of compute resources, implemented in accordance with an embodiment.

FIG. 2 is an example diagram of a cloud computing environment including a plurality of provisionable parallel processors, implemented in accordance with an embodiment.

FIG. 3 is an example diagram of an abstraction layer application communicating with an orchestrator and a contractor.

FIG. 4 is an example flowchart of a method for generating an abstraction layer based on a benchmark, implemented in accordance with an embodiment.

FIG. 5 is an example flowchart of a method for generating an electronic contract for providing compute resources, implemented in accordance with an embodiment.

FIG. 6A is an example diagram architecture utilizing a global compute exchange system, implemented in accordance with an embodiment.

FIG. 6B is an example diagram architecture of the market layer, implemented according to an embodiment.

FIG. 6C is an example diagram architecture of the application layer, implemented according to an embodiment.

FIG. 6D is an example diagram architecture of the clearing layer, implemented according to an embodiment.

FIG. 6E is an example diagram architecture of the risk management layer, implemented according to an embodiment.

FIG. 6F is an example diagram architecture of the exchange layer, implemented according to an embodiment.

FIG. 6G is an example diagram architecture of the blockchain layer, implemented according to an embodiment.

FIG. 7 is an example schematic diagram of a global compute exchange (GCX) system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

A Global Compute Exchange (GCX) computing system is described herein to address this critical issue by creating a decentralized marketplace utilizing multi-cloud computing environments that not only democratizes access to these resources but also ensures efficient, scalable, and fair compute power distribution and provisioning.

The Global Compute Exchange (GCX) architecture is divided into several layers, each with specific functions. The Market Layer includes participants such as hedgers, traders, and market makers. The App Layer hosts various applications and user interfaces for interaction with the GCX. The Clearing Layer consists of guarantors providing proof of compute capacity and ensuring delivery. The Risk Management Layer features APIs, SDKs, and a risk engine for monitoring. The Exchange Layer (offchain) operates the core trading functions for compute resources. The Blockchain Layer (onchain) contains the smart contract ecosystem, including staking, liquidation engines, DeFi connectors, compute validators, customer collateral, and insurance pools. This multi-layered structure ensures a secure, efficient, and transparent market for trading compute resources.

According to an embodiment, an exchange system leverages blockchain technology to create a transparent, secure, and efficient platform for provisioning compute resources. By using a token-based exchange, it is possible to incentivize the proper allocation and utilization of resources, with mechanisms for penalties and rewards that ensure compliance and performance. As noted by Ren et al., such approaches are crucial for managing billion-and trillion-scale model training sessions that require substantial computational efforts.

Advanced monitoring and predictive analytics are integrated in an embodiment to ensure proper risk management and that compute delivery is both reliable and efficient. The platform's capability to provide real-time analytics helps preempt potential failures, ensuring uninterrupted service delivery. This reliability is essential not only for maintaining service quality but also for building trust within the marketplace.

The GCX system provides a versatile platform that caters to various stakeholders in the compute market, enabling them to hedge against price volatility, secure future prices, and generate additional yield. According to an embodiment, the GCX system allows different actors to leverage its functionalities to their advantage. Alice, an AI startup founder, uses futures contracts to lock in the price of compute, safeguarding against future price increases. Bob, anticipating a market correction, buys put options to secure a price floor, thereby minimizing potential losses. Carol, a data center operator, sells both call and put options to collect premiums, generating additional yield. When these options expire worthless, she profits from the premiums, smoothing her revenue stream (producer hedge). By utilizing the GCX, these actors can effectively manage their risks and optimize their financial strategies in the dynamic compute market.

In some embodiments, the GCX system enables various expressions of market sentiment, allowing participants to profit and protect against the evolution of compute prices, whether they anticipate an increase, decrease, or sideways movement. This flexibility ensures that the GCX system provides benefit to a diverse range of market participants, each with their unique perspectives and strategies.

It is further advantageous, in an embodiment, to determine a price of compute in order to provision compute resources efficiently. The price of compute can vary widely based on factors such as demand, supply, technological advancements, and market conditions. Unlike traditional commodities, the compute market is influenced by a unique set of variables, making it challenging to pinpoint a stable price. The GCX system provides transparency and stability to this nascent market, enabling participants to better understand and manage the cost of compute resources, in some embodiments. By providing a system which makes compute resources accessible and efficiently managed, computational power is no longer a barrier to innovation but a widely available asset that drives global technological advancement.

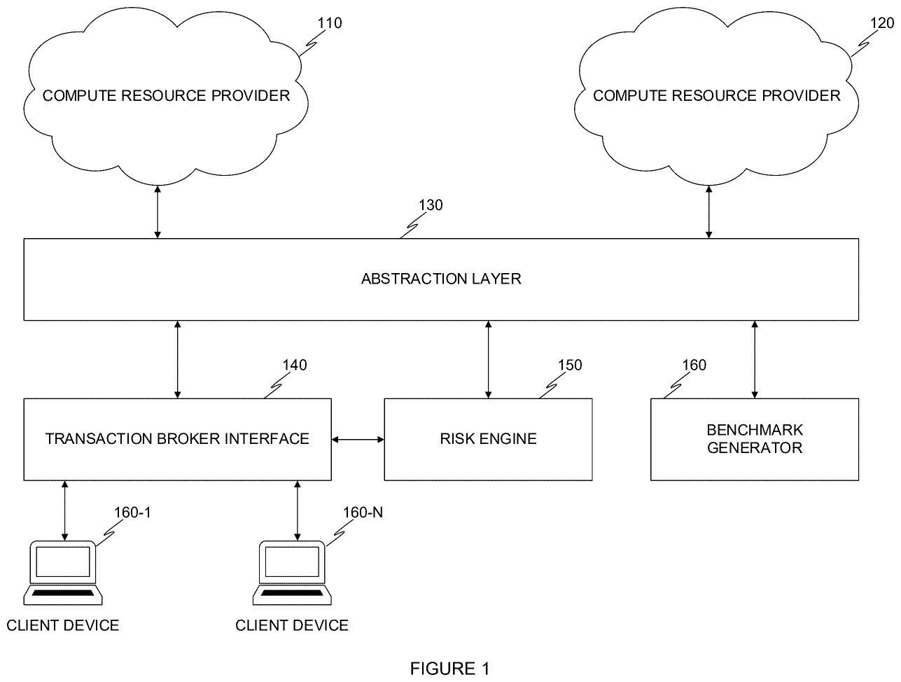

FIG. 1 is an example of a network diagram for providing commodification, abstraction, and provisioning of compute resources, implemented in accordance with an embodiment. In an embodiment, a plurality of compute resource providers 110 and 120 are connected to an abstraction layer 130. In some embodiments, a compute resource provider is 110, for example, Amazon Web Services, Google Cloud Platform, Microsoft Azure, and the like. In an embodiment, a compute resource provider 110 includes provisionable resources, such as GPUs, CPUs, memory, storage, a combination thereof, and the like.

In an embodiment, each compute resource provider 110 and 120 utilizes different types of resources. For example, a GPU type may include different architectures, different number of computational cores, different duty cycles, different clock cycles, a combination thereof, and the like.

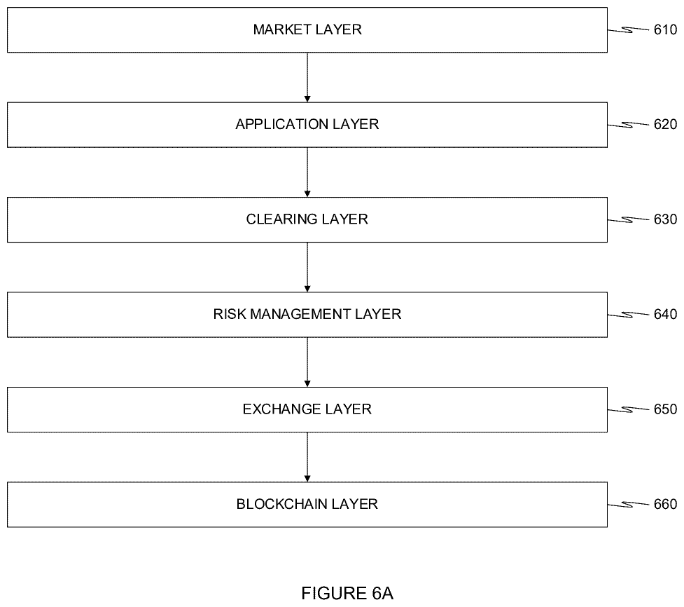

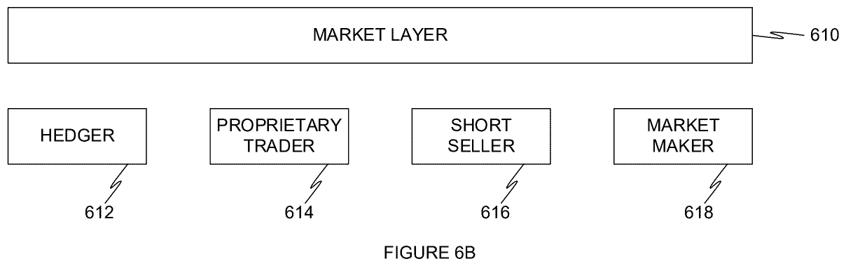

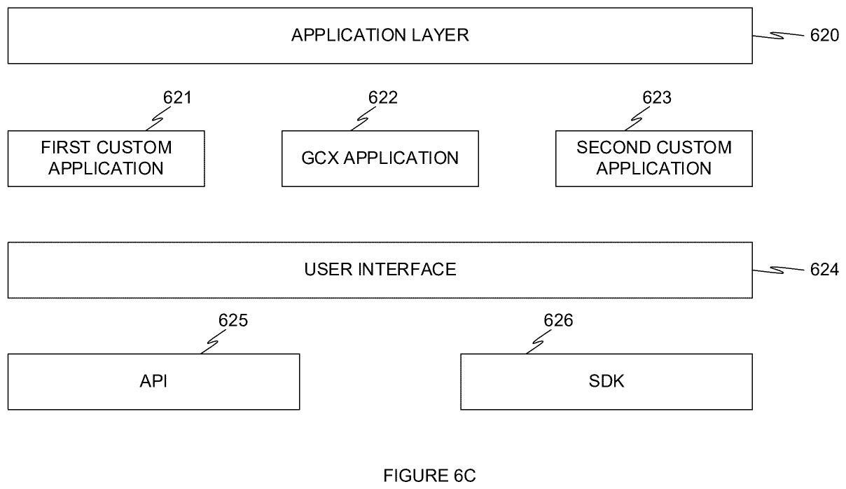

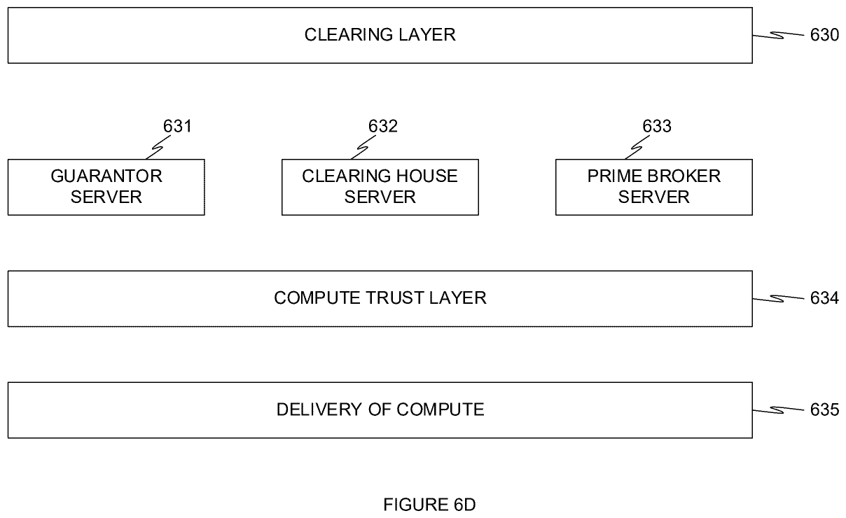

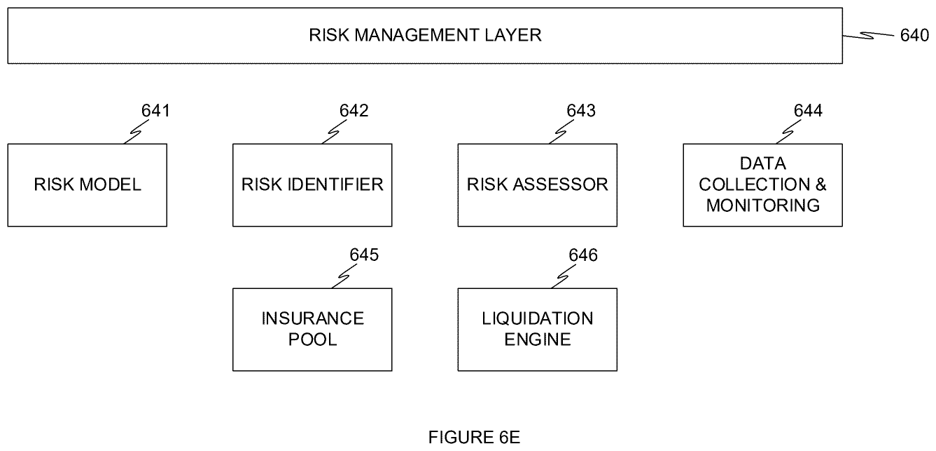

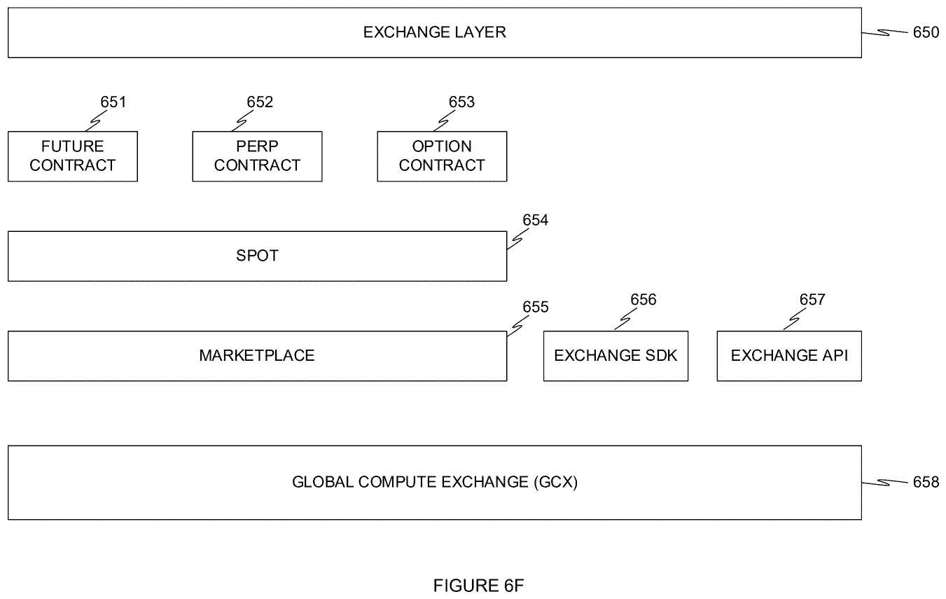

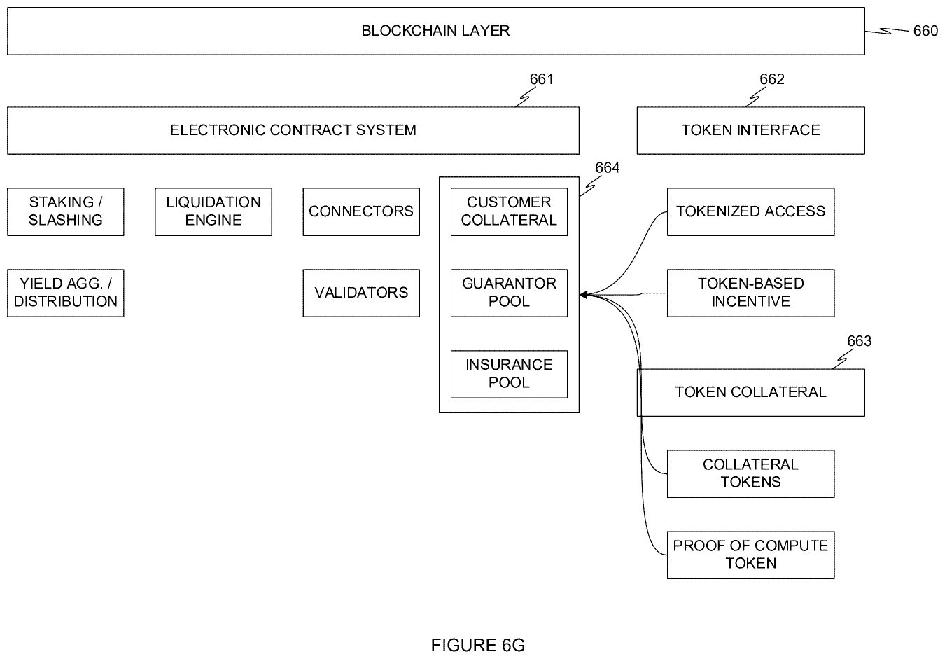

In some embodiments, the abstraction layer 130 is generated by a global compute exchange (GCX) platform, such as described in more detail herein. In an embodiment, the abstraction layer 130 is a component of the GCX platform (see e.g., FIG. 6A below).

According to some embodiments, the abstraction layer 130 is configured to utilize a data schema to translate each unique resource in the compute resource provider 110 to a standardized compute resource, which can then be provisioned, for example, based on a request and availability thereof. In some embodiments, a combination of a received request and determined availability is stored in a data record, also referred to as a contract.

In an embodiment, a transaction broker interface 140 is communicatively coupled with a plurality of client devices 160-1 through 160-N, where ‘N’ is an integer having a value of ‘2’ or greater, referred to individually as client device 160 and collectively as client devices 160. In some embodiments, a client device 160 is configured to request compute resources, provide compute resources, a combination thereof, and the like. In some embodiments, the request is based on a commoditized unit of compute, generated for example, as described in more detail herein.

According to an embodiment, a request includes a number of compute units, a network bandwidth request, a geographical location, a service level agreement, a combination thereof, and the like. In an embodiment, a compute unit, such as compute hours (described in more detail herein below), is determined based on a benchmark generator.

In certain embodiments, the transaction broker interface 140 is configured to provide the request, an identifier of the client device, a combination thereof, and the like, to a risk engine 150. In some embodiments, the risk engine 150 is configured to generate a risk profile based on the received request, and based on a risk score, a service level agreement, a combination thereof, and the like, which is associated with a specific compute resource provider.

According to some embodiments, a benchmark generator 160 is configured to detect a resource deployed in a compute resource provider 110 and submit the resource to a benchmark test. In an embodiment, a profile is generated for each detected resource, each detected resource type, etc. In certain embodiments, the benchmark generator 160 is configured to store the profile in the abstraction layer 130. In an embodiment, the abstraction layer 130 is implemented as a software application which is configured to translate a received request for compute resources to a request for specific compute resources from a compute resource provider 110.

In an embodiment, a transaction broker interface 140 is configured to receive a request from a client device 160 to allocate computing. In some embodiments, the transaction broker interface 140 is configured to generate a blockchain record, for example based on a smart contract, to segregate a deposit of a first client device 160-1 from a deposit of a second client device 160-2. In some embodiments, the transaction broker interface 140 is configured to determine a risk score for the request. In an embodiment, the risk score is determined utilizing a risk engine 150, including a plurality of rules, policies, heuristics, and the like.

In some embodiments, where the risk score is determined to be below a predetermined threshold, the transaction broker interface 140 is configured to execute the request, for example by sending the request to a matching engine (not shown), which is configured to detect available compute resources which can be allocated based on the request.

In certain embodiments, the transaction broker interface 140 is required to hold a minimum amount of collateral recorded on the blockchain, a minimum number of exchange tokens, a combination thereof, and the like.

In some embodiments, the transaction broker interface 140 is configured to continuously monitor client requests and provider allocations. In some embodiments, a pool of resources is allocated as a form of insurance, such that when a provider is unable to allocate compute resources which were allocated based on a contract, resources are allocated from the resource pool.

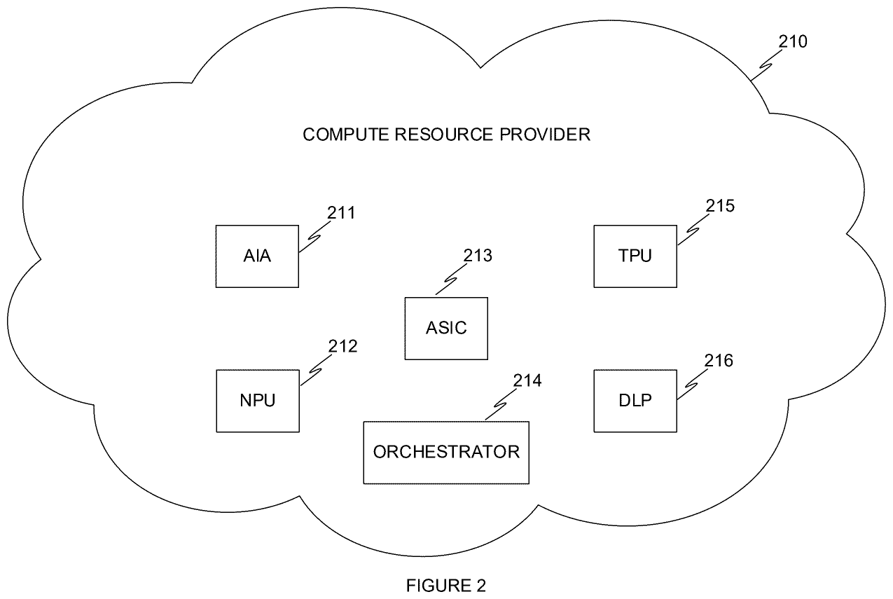

FIG. 2 is an example diagram of a cloud computing environment including a plurality of provisionable parallel processors, implemented in accordance with an embodiment. In an embodiment, a compute resource provider 210 includes a plurality of provisionable resources, such as artificial intelligence accelerator (AIA) processors 211, neural processing units (NPUs) 212, application specific integrated circuit (ASIC) 213, a tensor processing unit (TPU) 215, a deep learning processor (DLP) 216, a combination thereof, and the like.

In an embodiment, a computing environment of the compute resource provider 210 further includes an orchestrator 214 which is configured to provision a resource, such as a compute resource, to a specific task, a specific thread, a specific user account, a specific service account, a combination thereof, and the like.

According to an embodiment, each such resource deployed in the computing environment is applied a benchmark test, and a compute hour score is determined for each resource based on a result of the applied benchmark test.

In some embodiments, the benchmark test includes a performance metric. In an embodiment, the benchmark test includes an energy efficiency test. For example, power consumption can be measured under various different loads. In certain embodiments, a benchmark test includes an evaluation of performance across different architectures, different configurations, a combination thereof, and the like.

According to certain embodiments, a benchmark test is configured to execute on various platforms, such as x86, ARM, GPU architectures, and the like. This is known as a portable benchmark, and is advantageous in comparison and standardization of different computing architectures for the purpose of abstracting into a single compute type.

In some embodiments, the benchmark test includes a measurement of fault tolerance. In an embodiment, a failure is simulated to measure a provisioning system's capability to recover and maintain performance.

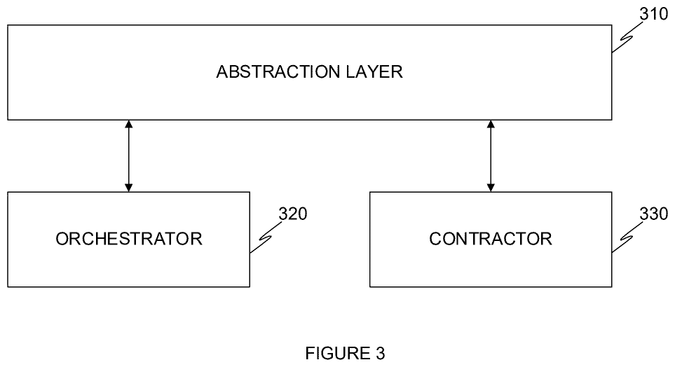

FIG. 3 is an example diagram of an abstraction layer application communicating with an orchestrator and a contractor. In an embodiment, a contractor 330 is configured to generate a contract based on a received request. In some embodiments, the contractor 330 is configured to provide the request, a portion thereof, and the like, to the abstraction layer application 310 and determine therefrom a compute resource, a plurality of compute resources, etc., which are provisionable based on the request.

In certain embodiment, the contractor 330 is configured to generate a contract, for example utilizing a blockchain system, between a client device, a client identifier, etc., and a compute resource provider (not shown). In an embodiment, an orchestrator 320 of the compute resource provider is configured to provide compute resources which are referenced in the contract generated by the contractor 330.

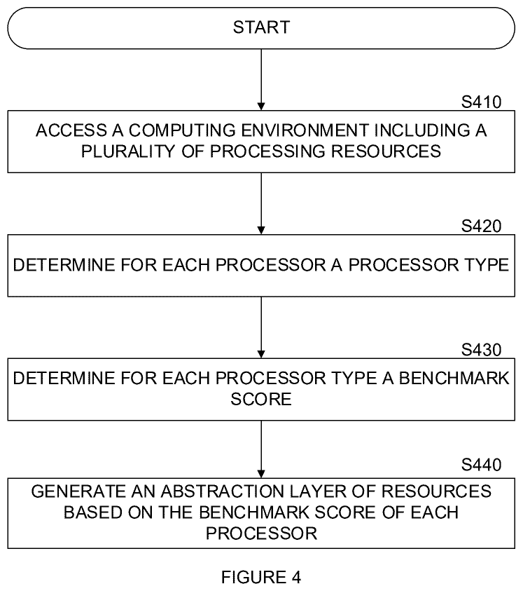

FIG. 4 is an example flowchart of a method for generating an abstraction layer based on a benchmark, implemented in accordance with an embodiment. As used throughout this disclosure, a processor is, or otherwise includes, a processing circuitry, implemented for example, as a CPU, GPU, GPGPU, ASIC, etc.

At S410, a computing environment is accessed. In some embodiments, generating an abstraction layer includes accessing a computing environment including a plurality of processor resources. In an embodiment, accessing a computing environment includes initiating a discovery process to detect resources which are provisionable resources. For example, in an embodiment, a plurality of different types of processors (i.e., processing circuitries) are detected in the computing environment.

At S420, a processor type is determined. In certain embodiment, for each processor resource, a processor type is determined. A processor type includes, according to an embodiment, an architecture type (e.g., x86, ARM, etc.), a number of cores, a number of computational threads, a number of SIMDs, a duty cycle, a clock cycle, a combination thereof, and the like.

At S430, a benchmark score is determined. In an embodiment, a benchmark score is determined for each processor type. For example, in some embodiments, a benchmark score is determined by applying a benchmark test to a processor of a first type, a plurality of processors of the first type, etc., in order to receive a result of the benchmark test. In some embodiments, the benchmark test includes a plurality of instructions for execution by the processor.

At S440, an abstraction layer is generated. In certain embodiments, the abstraction layer is generated based on mapping each benchmark score of each processor type to a predefined benchmarking score. For example, in an embodiment, a first benchmark test is determined to be computable in 1 unit of time. A processor completing the benchmark test (i.e., computing the benchmark test instructions) in 2 units of time receives a score of 0.5.

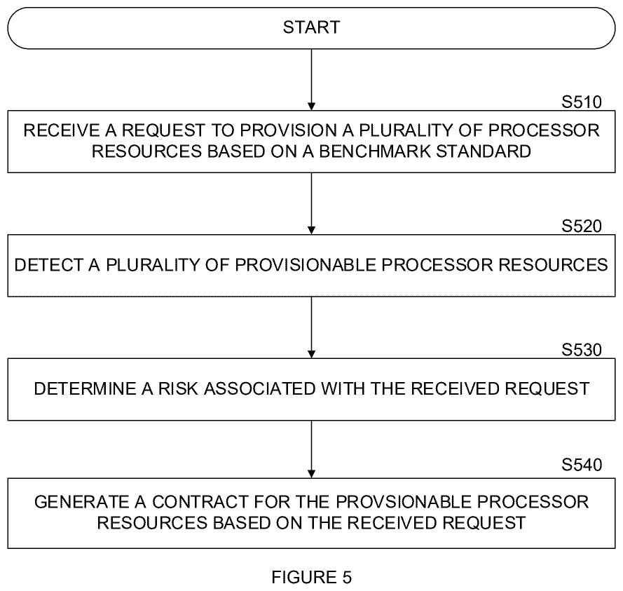

FIG. 5 is an example flowchart of a method for generating an electronic contract for providing compute resources, implemented in accordance with an embodiment.

At S510, a request is received for processor resources. In some embodiments, the method includes receiving a request to provision compute resources, such as processing circuitries (e.g., processors) based on a benchmark standard. In an embodiment, the benchmark standard is generated by a benchmark generator.

At S520, a plurality of processor resources are detected. In an embodiment, the plurality of processor resources are detected utilizing the method described for example, in FIG. 4 above. In some embodiments, a plurality of provisionable resources are detected. In certain embodiments a portion of the provisionable resources are from a first cloud computing environment, and another portion of the provisionable resources are from a second cloud computing environment. In certain embodiments, a cost is associated with each of the provisionable resources.

At S530, a risk score is determined. In an embodiment, the risk score is determined based at least on the received request. In some embodiments, the risk score is generated based on the received request. In certain embodiments, the risk score is generated based on the benchmark score, based on a reliability score, a combination thereof, and the like.

For example, in an embodiment, a reliability score is determined for a client device, a client identifier, a resource provider, an amount of resources provided, a time, a time frame, a combination thereof, and the like.

At S540, an electronic contract is generated. In certain embodiments, a contract is generated based on the received request and further based on the determined risk score. In an embodiment, the contract is stored on a blockchain data structure. In some embodiments, the contract stipulates a plurality of conditions, a price associated with the provisioned resources, etc. For example, the blockchain data structure is implemented utilizing Ethereum®.

FIG. 6A is an example diagram architecture utilizing a global compute exchange system, implemented in accordance with an embodiment. In an embodiment, the architecture includes the various systems described in more detail herein, including the global compute exchange system. Each layer will be discussed in more detail below, of which:

FIG. 6B is an example diagram architecture of the market layer, implemented according to an embodiment.

FIG. 6C is an example diagram architecture of the application layer, implemented according to an embodiment.

FIG. 6D is an example diagram architecture of the clearing layer, implemented according to an embodiment.

FIG. 6E is an example diagram architecture of the risk management layer, implemented according to an embodiment.

FIG. 6F is an example diagram architecture of the exchange layer, implemented according to an embodiment.

FIG. 6G is an example diagram architecture of the blockchain layer, implemented according to an embodiment.

The Global Compute Exchange (GCX) architecture is divided into several layers, each with specific functions. In an embodiment, the Market Layer 610 includes participants such as a hedger 612, a trader 614, a seller 616, and a market maker 618. In an embodiment, the hedger 612, trader 614, seller 616 are each implemented on a physical device, virtual device, etc., and are configured to communicate with each other over a network interface.

According to an embodiment, the Application Layer 620 hosts various applications, such as first custom application 621 and a second custom application 623, and a user interface 624 for interaction with the GCX application 622. In an embodiment, each application, such as first custom application 621 is configured to utilize an application programming interface (API) 625 to interact with the GCX Application 622, the user interface 624, etc. In certain embodiments, an application, such as the second custom application 623 is generated utilizing a software development kit (SDK) 626.

In some embodiments, the Clearing Layer 630 includes a guarantor server 631, a clearing house server 632, a prime broker server 633, and the like. In an embodiment, a guarantor server 631 is configured to provide proof of compute capacity. In some embodiments, the guarantor server 631 is configured to ensure delivery of compute based on fulfilment of an electronic contract.

In certain embodiments, the guarantor server 631 provides a compute trust layer 634, for example by providing delivery of compute 635, such as by allocating, provisioning, etc., a compute resource, and receiving over a network interface an indication, such as a data packet, indicating that the compute resource is received by the requestor device.

In an embodiment, the Risk Management Layer 640 features APIs, SDKs, and a risk engine for monitoring. In an embodiment, the risk engine includes a risk model 641. The risk engine is configured to receive a risk identifier 642 and the risk assessor 643 utilized the risk model 641 to determine a risk associated with a particular request for compute allocation. In some embodiments, the risk engine is configured to perform additional data collection & monitoring 644 to provide additional input for the risk engine to determine a risk associated with a request for a resource allocation.

In some embodiments, an insurance pool 645 includes a plurality of identifiers of compute resources which are received from various different providers which can be provided, for example when any one of the various different providers is unable, temporarily or permanently, to provide compute resources which were committed to be provided.

In an embodiment, a liquidation engine 646 is configured to receive the request, determine a risk utilizing the risk engine, and execute the request by implementing an electronic contract.

In certain embodiments, the Exchange Layer (offchain) 650 operates the core trading functions for compute resources. For example, in an embodiment, the exchange layer 650 includes a future contract 651, a perpetual future contract 652, an option contract 653, a spot contract 654, various combinations thereof, and the like. In an embodiment, such electronic contracts are available on a marketplace to be associated with a resource (i.e., the same resource can be delivered utilizing different contracts at different times).

In an embodiment, the global compute exchange (GCX) 658 utilizes the marketplace 655 through an exchange API 657. In some embodiments, custom application, such as discussed above, are implemented utilizing an exchange software development kit (SDK) 656.

In some embodiments, a Blockchain Layer (onchain) 660 includes an electronic contract system 661, including staking, liquidation engines, DeFi connectors, compute validators, customer collateral, and insurance pools. For example, the blockchain layer 660 utilizes a token interface 662 to provide access to the electronic contract system 661, such as customer collateral, guarantor pool, insurance pool, and the like. In some embodiments, this is also provided by form of a token collateral 663.

This multi-layered structure ensures a secure, efficient, and transparent market for trading compute resources.

Compute commodification refers to the process of transforming computational power into a standardized asset. Commoditization, on the other hand, refers to the process where goods become undifferentiated and subject to increased competition. In this way, compute commodified to enable its commoditization. Compute commodification involves defining discrete units of compute resources that can be bought, sold, and traded on a marketplace, similar to traditional commodities like electricity, oil, or metals. The commodification of compute resources ensures efficient resource allocation and fosters competitive pricing. By creating a standardized measure of compute power, it becomes possible to commodify and trade these resources efficiently and transparently. Transparent and efficient marketplaces for computational resources can significantly enhance resource utilization and market dynamics.

To an extent, cloud computing infrastructure provides such standardizations without a user having to concern themselves with the underlying hardware. However, this is not truly standardized as there is no transparency, and certainly no solution which allows standardization across multiple cloud computing infrastructure environments.

The commodification of compute resources offers several significant advantages. Firstly, it enhances market liquidity. By standardizing compute units, the market becomes more liquid, with a greater number of buyers and sellers able to participate. This increased liquidity makes it easier to trade compute resources. Furthermore, blockchain technology and smart contracts enhance transparency and trust in transactions, providing a secure and reliable platform for trading compute resources.

Secondly, the commodification of compute resources lowers transaction costs and enables market participants to express a more comprehensive outlook on the price of compute. This predictability and reduction in transaction costs benefit consumers and attract more providers to the market. By offering tools that cater to a diverse set of risk profiles, the GCX system ensures that the market is accessible to a wide range of participants, from large-scale data centers to smaller, niche providers. This allows expanding the overall pie, creating opportunities for all participants. The increased predictability and efficiency of the GCX platform support investment and growth in the compute market, making it an attractive space for innovation and expansion.

Thirdly, it provides flexibility and efficiency. Users can purchase compute power as needed, allowing for flexible scaling of resources based on demand. This dynamic allocation helps optimize resource usage and reduce wastage. Moreover, access to a marketplace for compute resources means that businesses and individuals can acquire the exact amount of compute power they need, when they need it, without long-term commitments and across multiple cloud computing platforms.

Lastly, commodification promotes accessibility and inclusivity. Compute commodification democratizes access to high-performance computing, allowing smaller businesses and individuals to leverage powerful compute resources that were previously accessible only to large corporations. Easier access to compute power can spur innovation and development, enabling new applications and technologies that rely on intensive computational resources. The substantial investments in AI alone, with over $28 billion raised by private AI companies since 2020, underscore the critical need for efficient compute resource management systems. This economic potential drives the demand for commodifying compute resources to support AI growth. The GCX is a marketplace where compute resources are as easily tradable as traditional commodities. We are building a platform that standardizes compute units, ensures reliable delivery through standardized contracts, and fosters a vibrant ecosystem of buyers and sellers.

Standardization of compute allows the GCX platform to create a robust derivatives market which will allow for better price transparency and risk management for all market participants. By commodifying compute power, new opportunities are unlocked for innovation, efficiency, and growth across various industries.

The demand for computational resources, especially GPUs, has surged dramatically due to advancements in AI and machine learning. What is more, the compute resource market faces significant challenges, including resource allocation inefficiencies, data privacy and security issues, and competitive barriers for small and medium-sized enterprises. The requirements for AI models have grown exponentially, with compute needs increasing by 70 times from GPT-3 to GPT-4.

This highlights the urgent need for scalable and efficient compute resource management solutions to meet the growing demands of AI technologies. This increased demand has resulted in a significant supply crunch, making computational power both expensive and difficult to access for many startups and independent developers. The concept that “compute is the new oil” encapsulates this paradigm shift, highlighting the critical role that computational resources play in driving technological innovation and economic growth.

Decentralized Physical Infrastructure Networks (DePINs) have emerged as a solution to the challenges of accessing computational resources. By creating decentralized marketplaces, DePINs enable individuals and organizations worldwide to offer their idle compute power. This approach not only democratizes access to computational resources but also drives down costs through increased competition and resource utilization efficiency.

Despite their potential, compute DePINs face several technical and economic challenges. Competing with and working alongside centralized providers requires overcoming issues related to scalability, reliability, and cost-effectiveness. However, the integration of blockchain technology and smart contracts within these networks can help mitigate these challenges by providing secure, transparent, and efficient platforms for trading compute resources.

The imbalance between the supply and demand for compute resources presents a significant market opportunity. By leveraging a decentralized solution, the Global Compute Exchange (GCX) platform can bridge this gap, making computational power more accessible and fostering a more inclusive environment for AI development. This democratization of compute power is crucial for enabling innovation across various sectors, from startups to educational institutions and research organizations.

Building the GCX platform is vital for several reasons. Firstly, it addresses the growing demand for computational resources by creating a decentralized marketplace that can efficiently match supply with demand. This is essential for ensuring that the burgeoning field of AI and machine learning continues to advance without being hampered by resource constraints. Secondly, the GCX platform provides a platform that democratizes access to high-performance computing, allowing a broader range of participants, including startups, researchers, and institutions from economically disadvantaged regions, to access the computational power they need to innovate and grow.

Furthermore, the GCX platform can enhance the availability and affordability of computational resources by fostering competition among providers and improving resource utilization through its decentralized model. This increased accessibility is crucial for making advanced computational capabilities available to a wider audience. Additionally, by leveraging blockchain technology and smart contracts, the GCX platform ensures secure, transparent, and efficient transactions, which build trust among participants and promote the stability of the marketplace.

The establishment of the GCX platform is not just about meeting current computational demands but also about future-proofing the industry. As AI and machine learning technologies continue to evolve, the need for scalable and flexible computational resources will only increase. The GCX platform is positioned to meet these needs, ensuring that computational power becomes a readily available and manageable commodity, much like electricity or data storage. This ultimately drives innovation, economic growth, and technological advancement on a global scale.

An innovative approach in the compute resource lifecycle is the transformation of oil and its byproducts into “digital oil.” Excess gas from oil extraction sites, often flared due to insufficient transportation infrastructure, can be repurposed to power compute datacenters. By converting this otherwise wasted energy into electricity, these datacenters can generate substantial computational power, contributing significantly to the global compute pool. Additionally, oil itself can directly fuel these sites, providing a primary energy source for computational tasks. This dual utilization not only offers an additional revenue stream for oil companies but also promotes more sustainable use of natural resources. Integrating traditional energy sources with digital infrastructure enhances the efficiency and profitability of both sectors, showcasing a forward-thinking approach to energy and technology.

Beyond traditional and byproduct energy sources, renewable energy offers a sustainable and efficient means to power the global compute market. Solar, wind, hydroelectric, and geothermal energy can all be harnessed to run compute datacenters, reducing the carbon footprint and promoting environmental sustainability.

Renewable energy provides a reliable and scalable solution to meet the increasing demand for computational power. For instance, solar farms can generate substantial electricity during peak sunlight hours, which can be stored and utilized by compute datacenters. Wind turbines, strategically placed in high-wind areas, can provide consistent energy to power these facilities. Hydroelectric plants, leveraging natural water flow, and geothermal plants, utilizing the Earth's internal heat, offer continuous energy supplies, ideal for the 24/7 operation of datacenters.

Integrating renewable energy sources into the compute infrastructure reduces dependency on fossil fuels and minimizes greenhouse gas emissions. This not only aligns with global sustainability goals but also enhances the resilience and stability of the compute market by diversifying energy sources. Moreover, renewable energy-powered compute datacenters can attract environmentally conscious businesses and investors, fostering innovation and growth in the green technology sector.

The adoption of renewable energy in the compute market underscores a commitment to creating a more sustainable and eco-friendly digital economy, ensuring that the expansion of computational power does not come at the expense of the environment.

In the compute resource lifecycle, the upstream stage involves the generation and provision of raw compute resources, akin to oil extraction. Key players in this stage include data centers, cloud service providers, and decentralized compute providers. Data centers are facilities that house the physical servers and infrastructure necessary for generating compute power. Cloud service providers, such as AWS, Google Cloud, Azure, Nexgen Cloud, and Oracle, offer large-scale compute resources. Additionally, decentralized compute providers are individuals or smaller entities that contribute spare computing power via decentralized networks.

The midstream stage involves the aggregation, optimization, and distribution of compute resources, ensuring they are available where and when needed. This stage is analogous to the transportation and storage of oil. Key components include resource scheduling and allocation platforms, task queues and orchestration services, and resource brokerage. Resource scheduling and allocation platforms manage the distribution of compute tasks to available resources, optimizing for efficiency and cost. Task queues and orchestration services handle the queuing and orchestration of compute tasks, ensuring efficient utilization of resources. Resource brokerage involves marketplaces where compute resources are traded, including futures contracts and spot markets.

The downstream stage, similar to refining and retail in the oil industry, involves the use of compute resources for various applications. End-user applications are the final consumers of compute power, such as AI model training, data processing, and running complex simulations. Enterprise solutions are companies that use compute resources for their business operations, including big data analytics, machine learning, and SaaS products. Compute-intensive services rely heavily on compute power and include areas such as video rendering, gaming, and scientific research.

The refinery stage in the compute resource lifecycle involves optimization services, similar to oil refineries that convert crude oil into usable products. These services enhance raw compute power into more efficient and valuable resources. AI model optimization techniques improve the performance and efficiency of AI models. Performance tuning involves adjusting and optimizing software and hardware settings to maximize compute efficiency. Resource virtualization allows for more efficient use of physical hardware by creating virtual resources.

This section expands on the comparative analysis of the power and computational resource markets by specifically focusing on the metrics used in each market. This detailed comparison aims to highlight how these metrics influence market operations and the potential for adopting analogous measures across markets to improve performance and stability.

Both the compute resource market and the power market share several similarities, such as the need for real-time balancing, price volatility, and the importance of reliable delivery. However, they also have key differences. Unlike power, compute resources can be queued and scheduled, offering opportunities for innovative efficiency optimizations not possible in the power market. By adopting and adapting methodologies from the power market, we can enhance the operational efficiency, reliability, and sustainability of the compute resource market. In the power market, the following metrics play a key role in maintaining efficiency, reliability, and sustainability: Watt-hours (Wh): Measures the quantity of power used, serving as the fundamental unit for billing and trading. Frequency and Voltage: Critical for ensuring the stability and quality of the electrical supply. System Average Interruption Duration Index (SAIDI) and System Average Interruption Frequency Index (SAIFI): Assess the reliability and availability of the power supply. Power Factor: Indicates the efficiency of power use, affecting how much charge users incur. Emissions Intensity: Measures the environmental impact per unit of power generated, increasingly relevant in carbon trading schemes.

Similarly, the following metrics are proposed for the compute market, according to an embodiment: Compute Hours: Analogous to Wh, measuring the quantity of computational work done. Latency and Throughput: Key performance metrics that determine the efficiency and speed of data processing. Mean Time Between Failures (MTBF) and Mean Time to Repair (MTTR): Indicators of system reliability and service continuity, similar to SAIDI/SAIFI. Utilization Efficiency: Measures how effectively compute resources are being used, akin to the power factor in electricity. Energy Efficiency: Reflects the power consumption per unit of compute work, parallel to emissions intensity in highlighting sustainability.

While both markets share similarities in metric goals, the physical nature of power demands real-time balance and immediate consumption, posing unique challenges not faced in the compute market. Conversely, the compute market's flexibility in queuing and scheduling tasks offers opportunities for innovative efficiency optimizations not possible in power markets which require unique solutions such as those proposed herein. The detailed examination of market metrics reveals significant opportunities for mutual learning between the power and compute resource markets. By adopting and adapting methodologies and metrics from the power market, the compute resource market can enhance its operational efficiency, reliability, and environmental sustainability, fostering a more robust and equitable marketplace.

To standardize compute units, the Compute Hour (CH) is utilized, according to an embodiment, which abstracts the complexities of different hardware architectures and provides a consistent measure of computational work; this defines the compute commodity. Towards this, defining a reference system is a foundational step in this process. The reference system has a balanced performance profile, encompassing CPU, GPU, memory, and storage capabilities. Benchmarking this system involves running a suite of standardized tests to measure performance across various dimensions, ensuring fair and accurate trading of compute resources.

In some embodiments, these tests are run periodically, continuously, etc., on each of a plurality of different cloud computing provider environments. For example, in an embodiment, a benchmark test is initiated on a GPU core provided by AWS, and the benchmark test is initiated on another GPU core provided by GCP. In some embodiments, a benchmark test includes a plurality of computing instructions which are provided to the GPU for execution, and the system is configured to measure various metrics, such as time to produce a result, for each instruction of the plurality of instructions.

Also, it is difficult to use a compute cycle itself as a fundamental unit. A compute cycle represents a single instruction period of a computer's central processing unit (CPU) or graphics processing unit (GPU). One cycle is the time it takes for a CPU or GPU to fetch an instruction, decode it, execute it, and store the result. On the surface, measuring compute resources by counting the number of compute cycles seems straightforward—similar to counting revolutions on a power meter for kWh. This approach suggests a direct measurement of “work done” by the computing systems.

However, different CPUs and GPUs have different architectures (e.g., x86 vs. ARM for CPUs, and NVIDIA vs. AMD for GPUs), and their cycles cannot be directly compared. What one CPU or GPU can achieve in a single cycle might take another multiple cycles, or vice versa. Different CPUs and GPUs operate at different clock speeds, meaning the number of cycles per second can vary widely. Thus, compute cycles alone do not provide a uniform standard of measurement across different hardware.

Modern CPUs and GPUs can execute multiple instructions per cycle through techniques like pipelining and parallel execution. Therefore, the efficiency of cycle usage can vary, complicating a direct comparison based solely on cycle count. Different CPUs and GPUs support different sets of instructions (Instruction Set Architecture), and some can achieve more per cycle than others depending on the instruction mix. Operating systems and software optimizations play a significant role in how efficiently these cycles are used.

The CH abstracts away these complexities and provides a consistent measure of computational work. This ensures fair and accurate trading of compute resources in the marketplace, regardless of the underlying hardware differences:

$$Compue Hours ( CH ) = \frac{Performance ( FLOPS )}{Reference Performance ( FLOPS )} \times Operational Hours$$

Where Performance (FLOPS) is the actual performance output of the compute system measured in FLOPS. Reference Performance (FLOPS) is the benchmark performance of the reference system, also measured in FLOPS, and Operational Hours, or physical/wall-clock hours, is the duration in hours for which the system is utilized for computing tasks. FLOPS stands for floating-point operations per second, a measure of computational performance, especially in tasks involving real-number calculations common in AI and machine learning.

This formula allows for the normalization of computing performance across different systems and configurations. By using a reference system as a baseline, the Compute Hours for any system can be calculated by scaling its performance relative to this standard benchmark. This scaling ensures that a Compute Hour represents the same amount of computational work, irrespective of the underlying hardware differences.

Mapping the size of an AI training model to the amount of compute time needed can be approached by understanding the relationship between the model's architecture, the dataset, and the computational resources used.

An example embodiment is presented to estimate the compute time based on model size. The model architecture is known in detail, but this does not affect the generality of the result. Consider a Convolutional Neural Network (CNN). The CNN processes an input image through several layers, each performing specific operations. The raw input image fed into the network. Convolutional layers that apply filters extract features from the input image. Pooling layers reduce the spatial dimensions of the feature maps, retaining important information while reducing computational load. Fully connected layers combine the features learned by convolutional and pooling layers to make final predictions. The output layer provides the probability distribution over classes.

The number of layers, types of layers (e.g., convolutional, fully connected), and the number of parameters in each layer are utilized by the system to estimate the compute based on the model architecture. Types of operations involved, such as matrix multiplications, convolutions, and activations, are also utilized in an embodiment.

In an embodiment, the number of FLOPs for each layer is calculated. For example, a convolutional layer's FLOPs can be estimated using:

$$FLOPS per layer = 2 \times input height \times input width \times input channels \times output channels \times kernel height \times kernel width \times output height \times output width$$

Total FLOPs are a sum of the FLOPs for all layers to get the total FLOPs required for one forward pass. In an embodiment, a number of epochs (complete passes through the training dataset) is also determined and utilized to estimate compute hours for the model.

In certain embodiment, additional parameters of training iterations, such as batch size (Number of samples processed at once), iterations (total number of iterations as total samples/batch size), and the like, are determined and utilized in estimating compute hours for the model.

For example, a given model is determined to have: 1 trillion FLOPs (1 TFLOP) per forward pass, 1 million samples, a batch size of 256, and 10 epochs. This results in:

$$Total FLOPS needed = {10}^{12} Model Flops \times ( \frac{{10}^{6} samples}{256 batch size} ) \times 10 epochs = 39 Performance FLOPs ( PFLOPs )$$

By specifying further over which duration this needs to be completed we can obtain a rate: This is “Performance (FLOPS)” in the above equation; the amount of CH follows from that. This estimate is utilized in generating a request from the GCX platform for a specific numbers of PFLOPs when also specifying when the computation needs to take place. To be sure, the concept of Compute Hour can be generalized beyond AI.

Finally, let us say the AI model details are not known. We can still estimate the total number of FLOPs by using a reference GPU. This is something that can be provided on the GCX as well. This method allows us to guide users to the appropriate market for trading and provides valuable recommendations based on the computational requirements.

As part of defining the Compute Hours a reference system is provided. This is a foundational step in standardizing compute units and facilitating the commodification of compute resources. In an embodiment, the system includes a robust and credible framework for measuring and comparing computational power. This framework ensures that all compute resources are evaluated on a consistent, objective, and fair basis, promoting transparency and efficiency in the compute marketplace. This is possible due to the comparison capability of a computing system, which humans are incapable of on two levels. First, humans apply subjective criteria, and the human mind is incapable of applying objective criteria for benchmarking. Second, human minds are incapable of applying such objective criteria for the periods of time, and the speed at which such criteria need be applied. Often such execution is required to occur within seconds, milliseconds, etc., which the human mind is simply incapable of performing, and certainly not at a scale of a cloud computing platform.

Benchmarking involves running a suite of standardized tests to measure a system's performance across various dimensions, such as processing speed, memory bandwidth, and input/output operations. The results of these tests are then compared to the reference configuration to determine the equivalent number of Compute Hours.

For example, if a high-performance server is twice as fast as the reference configuration in executing the benchmark suite, it would be equivalent to two Compute Hours per physical hour of operation. Conversely, a less powerful system that achieves half the benchmark performance would be rated at 0.5 Compute Hours per physical hour.

The establishment of a reference system is pivotal in standardizing compute units and ensuring fair benchmarking across different compute resources. A reference system serves as a benchmark against which the performance of other systems is measured. This process is akin to how supercomputers are benchmarked to assess their performance.

The following criteria are considered when configuring the reference system, according to some embodiments. Performance: The reference system has a balanced and representative performance profile, encompassing CPU, GPU, memory, and storage capabilities. Availability: It should be based on commercially available hardware to ensure that the benchmarks are reproducible. Documentation: Comprehensive documentation of the hardware and software configurations, including operating systems and drivers, must be available. Scalability: The system should be scalable to allow for adjustments in benchmarking as technology advances.

In the supercomputing world, benchmarks like the High Performance Linpack (HPL) are used to evaluate and rank supercomputers. Additional benchmarks like HPCG (High Performance Conjugate Gradients), STREAM (memory bandwidth), and SPEC CPU (single-thread performance) can also be used for specific aspects of performance, in an embodiment. The HPL benchmark measures a system's floating-point computing power and is the basis for the TOP500 list of the world's most powerful supercomputers. Similarly, using a standardized benchmark suite to evaluate and define the reference system which can include, in some embodiments, at least an established benchmark, a plurality of commercially available benchmarks, and the like.

Benchmarking GPUs to define a compute hour involves measuring the performance of the GPU in terms of computational tasks over a specific period. The first step is to define the benchmarking metrics. These include FLOPS (Floating Point Operations Per Second), which measures the raw computational power; throughput, which measures the number of tasks or operations the GPU can handle per unit of time; latency, which measures the time taken to complete a single operation or task; power consumption, which measures the energy efficiency of the GPU; and memory bandwidth, which measures the speed at which data can be read from or written to the GPU's memory.

Next, select benchmarking tools and software. Established tools such as SPECviewperf, Geekbench, 3DMark, GPGPU Benchmarks like Rodinia or Parboil, and Deep Learning Benchmarks such as MLPerf are commonly used. Set up the testing environment, ensuring the GPU is installed in a standard configuration that matches common usage scenarios and that the necessary drivers, benchmarking tools, and specific software libraries are installed.

Run synthetic benchmarks to simulate various computational tasks, which could include matrix multiplications, deep learning model training, rendering tasks, or other GPU-intensive operations. Tools like CUDA-Z, OpenCL Benchmark, Blender for rendering tests, and TensorFlow/PyTorch for deep learning tasks are useful for this purpose. In addition to synthetic benchmarks, run real-world benchmarks using applications relevant to the target use case, such as Blender for rendering, Adobe Premiere Pro for video editing, and TensorFlow/PyTorch for machine learning.

Collect and analyze the performance data, measuring metrics such as FLOPS, task completion time, throughput, and power consumption during the benchmarks. Monitoring tools like NVIDIA-SMI can log performance data. Normalize the results to standardize the compute hour definition. For example, if a GPU completes a certain benchmark task in 30 minutes, it would have utilized 0.5 compute hours if the task is defined as a 1 compute hour benchmark. Aggregate the performance data to define a compute hour for the GPU, based on the average performance across different benchmarks or a weighted score that emphasizes specific tasks.

Examples of existing processes for benchmarking include MLPerf, which provides a suite of benchmarks for evaluating machine learning performance, including training and inference benchmarks for various neural network models. SPECviewperf benchmarks graphics performance by running a series of tests using real-world applications, measuring the ability of GPUs to handle 3D graphics workloads. Geekbench offers a cross-platform benchmark that measures CPU and GPU performance, including tests for various compute tasks. 3DMark is widely used for benchmarking gaming performance, running a series of graphics and computational tests to evaluate the capabilities of GPUs in gaming scenarios.

Setup: Install an NVIDIA RTX 3080 in a test machine with the latest drivers. Set up TensorFlow with CUDA and cuDNN.

Synthetic Benchmark: Run CUDA-Z to measure FLOPS. Execute TensorFlow benchmarks with a ResNet-50 model to measure training time and throughput.

Real-World Benchmark: Use Blender to render a high-resolution 3D scene. Run inference benchmarks with TensorFlow using a pre-trained BERT model.

Data Collection: Record the time taken for each task. Measure power consumption using NVIDIA-SMI. Log memory bandwidth utilization during the tasks.

Analysis: Calculate the average performance metrics. Normalize the results to define the compute hour based on task completion times and energy efficiency.

Report: Publish the normalized results, defining the compute hour for the RTX 3080 based on the aggregated performance data.

By following these steps and leveraging existing benchmarking tools and methods, the compute hour for a GPU can be accurately defined and standardized, allowing for fair and transparent trading in platforms like the GCX.

Once the reference system's performance metrics are established, other compute resources can be normalized to this standard. The normalization process involves comparing a system's benchmark results to those of the reference system. The formula for calculating Compute Hours, as previously discussed, is applied to perform this conversion.

For example, if the reference system achieves 1 TFLOP in the benchmark test, and another system achieves 0.5 TFLOPs, the latter would be assigned 0.5 Compute Hours for every physical hour of operation. Conversely, a system achieving 2 TFLOPs would be assigned 2 Compute Hours per physical hour.

As technology evolves, it is crucial to periodically update the reference system to reflect advancements in computational hardware and software. Regular updates ensure that the bench-marking process remains relevant and accurate. The criteria for updates include: Technological Advancements: Incorporating new hardware and software innovations. Market Trends: Reflecting shifts in the computational resource market. Feedback from Stakeholders: Considering input from compute providers and users.

By maintaining an up-to-date reference system, we ensure that the commodification of compute resources remains fair, transparent, and aligned with current technological standards.

Compute resources can vary widely in terms of performance, reliability, and suitability for different tasks. To facilitate transparent and efficient trading, we will grade compute resources based on their benchmark performance and additional criteria such as uptime, reliability, and energy efficiency.

Performance grades categorize compute resources into tiers based on their benchmark results. For instance: Grade A: High-performance systems with benchmark results significantly above the reference configuration. Grade B: Systems with performance moderately above the reference configuration. Grade C: Systems with performance close to the reference configuration. Grade D: Systems with performance below the reference configuration.

Reliability is crucial for many computational tasks. Compute resources will be graded on their historical uptime and failure rates. For instance: Grade 1: Systems with uptime exceeding 99.9%. Grade 2: Systems with uptime between 99.0% and 99.9%. Grade 3: Systems with uptime between 95.0% and 99.0%. Grade 4: Systems with uptime below 95.0%.

Energy efficiency is increasingly important in modern computing. Compute resources will be graded based on their energy consumption relative to their performance. For instance: Grade X: Highly energy-efficient systems with low power consumption per Compute Hour. Grade Y: Moderately energy-efficient systems. Grade Z: Systems with higher energy consumption.

Implementing a grading system for compute resources based on performance, reliability, and energy efficiency can significantly promote the use of ESG (Environmental, Social, and Governance)-friendly sources of compute. By providing clear and transparent benchmarks, users can make informed decisions about the sustainability and efficiency of their computational resources. For instance, high-performance grades (e.g., Grade A) combined with high energy efficiency grades (e.g., Grade X) will enable users to select top-tier compute resources that not only meet their performance needs but also align with their environmental sustainability goals. The price point difference will encourage data centers and compute providers to adopt greener technologies and practices to achieve higher grades, thereby reducing the carbon footprint of computational activities. Ultimately, this fosters a market where environmental responsibility and efficiency are rewarded, driving innovation and sustainability in the computing industry.

At the heart of the GCX platform lies the innovative concept of clearing and guarantee pools, where participants and guarantors play a crucial role in ensuring the integrity and efficiency of the compute market. Critical to a well-functioning commodities futures market are the following elements: Convergence of Futures Price to Spot Price: At expiration, the futures price must converge to the actual spot price of the underlying commodity. This is typically accomplished by ensuring that holders of long positions in futures contracts can take delivery of the underlying asset, while short position holders are obligated to deliver the asset as per the contract terms. Adaptive Risk/Margin System: A well-defined risk/margin system that can adapt to changing market conditions is essential. Mechanisms must be in place to ensure that sufficient margin is held by market participants. Margin Maintenance and Liquidation Mechanisms: Ensuring that market participants maintain sufficient margin and providing mechanisms to liquidate positions that fail to meet margin requirements are crucial for market stability. Backstop Liquidity Pool: A liquidity pool that can cover losses in case liquidated accounts do not have sufficient funds to meet their obligations is crucial. This pool acts as a safety net to ensure market stability.

In traditional financial markets, these have long been established by major exchanges. However, the industry is transitioning from older portfolio risk models (e.g., CME SPAN) to more modern Value at Risk (VaR) methods. For the GCX platform, in an embodiment, a margin system is implemented based on the latest advances in risk management techniques, unencumbered by legacy systems.

Certain functions were traditionally provided by clearing members at major exchanges. Non-clearing market participants must have their trades guaranteed by a clearing member, who is ultimately responsible for ensuring the financial obligations of its customers. Clearing members must also keep customer funds segregated from their own.

In the context of the GCX platform, Guarantee Pools can assume the role of traditional clearing firms by ensuring adequate margin is kept by their customers, that such margin is segregated from the pool's funds, and that liquidations can be enforced. Blockchain technology is utilized to facilitate this process.

Additionally, an Insurance Fund can serve as a final backstop against any financial losses resulting from a pool being unable to meet its obligations. All pools would be required to stake tokens to the Insurance Fund in proportion to their overall risk. The exchange itself (GCX) would also stake tokens into the Insurance Fund to align all parties' interests in maintaining proper risk controls. Furthermore, outside participants can contribute tokens to the Insurance Fund in return for yield, enhancing the pool's robustness and providing additional incentives for risk management.

The GCX platform is structured into several distinct layers, each with specific roles and responsibilities. This multi-layered architecture ensures a robust and efficient operation of the compute market, leveraging blockchain technology for enhanced transparency and security. The layers and their interactions are illustrated in the accompanying figures. The Market Layer comprises the participants who interact with the GCX to trade compute resources. These participants include: Hedgers: Entities seeking to hedge against price volatility in compute resources, Traders: Participants who engage in buying and selling compute resources to profit from price movements, Short Sellers: Entities that sell compute resources they do not currently own, betting on future price declines, and Market Makers: Entities that provide liquidity to the market by continuously quoting buy and sell prices. These market makers, leveraging their high trading volumes, may opt to purchase GCX tokens to benefit from reduced transaction fees.

The App Layer consists of applications developed by various companies, including the GCX itself. These apps provide user interfaces and frontends for interacting with the GCX platform. Key components include: GCX's App: The primary application developed by the GCX for trading compute resources, Company 2's App: An example of a third-party application integrated with the GCX, Company 3's App: Another example of a third-party application integrated with the GCX, and the User Interface+Frontend: Interfaces that allow users to interact with the apps and manage their trading activities.

The Clearing Layer facilitates smooth and secure trade settlements. It includes guarantors who provide trade guarantees and manage the delivery of compute resources. Guarantors also serve as gatekeepers to the GCX, ensuring market participants maintain sufficient collateral to cover their risk both pre-and post-trade. Key components include: Guarantor 1, 2, 3: Entities that guarantee the fulfillment of trades. Guarantors may be subject to losses of their own collateral if a customer's collateral is insufficient to cover losses in case of default. This incentivizes Guarantors to maintain proper risk controls over their customers.

Proof of Compute/Capacity (e.g., via DePIN+Truebit): Mechanisms to verify the availability and delivery of compute resources.

Delivery of Compute: The process of delivering compute resources as per the contract terms.

The Risk Management Layer monitors and manages the risks associated with trading on the GCX. It includes: APIs and SDKs: Tools for developers to integrate their app into the GCX and to integrate risk management features into their applications as well, and a Risk Engine: Monitoring and Analytics: Systems that analyze and monitor risk factors to ensure market stability. The risk engine also scores the participants and ensures the entire health of the platform.

The Exchange Layer manages the off-chain operations of the GCX, including matching buy and sell orders and executing trades. It is also responsible for determining which products and derivatives are listed and establishing risk scoring utilizing a risk engine. Key components include: Global Compute Exchange (GCX): The core exchange platform for trading compute resources, and Marketplaces (Spot, Derivatives: Futures, Options): Various marketplaces within the GCX for trading different types of compute contracts.

The Blockchain Layer manages the on-chain operations, leveraging blockchain technology for transparency and security. It includes: Smart Contract Ecosystem: A system of smart contracts that govern the operations of the GCX, Token Interface (GCX Token): The primary currency used within the GCX ecosystem, Token Collateral: Tokens used as collateral for trades, including collateral tokens (USDC, USDT) and proof of compute tokens, Customer Collateral (Segregated): Collateral provided by customers, kept separate from the pool's funds, Guarantor Pool Collateral, GCX tokens, Proof of Compute: Collateral provided by guarantors to back their guarantees, Insurance Pool: A pool of funds to cover losses in case of defaults, Staking and Slashing: Mechanisms to ensure compliance and penalize non-performance, Yield Aggregation/Distribution: Systems to distribute earnings to participants, Liquidation Engine: Systems to liquidate positions that fail to meet margin requirements, Connectors to broader DeFi Ecosystem: Integrations with the broader decentralized finance ecosystem for additional liquidity and services, Workflow of the GCX App for Short and Long Futures: This process starts with the expiration of a future contract, either short in the GCX App or long in a company-built app. Guarantors match participants to deliver the compute resources. The short participant is required to deliver to the long. If the short can deliver, the buyer pays, and the compute is delivered. If the short fails to deliver, their staked tokens are slashed, and the buyer is compensated. The reputation score and risk engine are updated accordingly in the risk management layer.

The process flow for clearing and guarantee pools within the GCX involves multiple steps with the goal to ensure that the platform operates smoothly and securely. When a market participant initiates a trade through the app layer, their guarantor acts as a gatekeeper. Before submitting the trade to the GCX matching engine, the guarantor ensures that the participant has sufficient collateral to cover the associated risk.

The selected participant attempts to deliver the compute resources. Successful delivery results in the compute being provided to the buyer, while failure to deliver results in the slashing of the participant's staked tokens.

Exercising an option would typically result in the delivery of its underlying futures contract and therefore would not trigger immediate delivery of compute resources. For OTC (over-the-counter) and spot trades, these are settled directly by the counter-parties involved. The primary scenario for delivery to occur is when a futures contract reaches expiration.

According to an embodiment, delivery of compute hours primarily occurs as a result of a GCX futures contract coming to expiration. In some embodiments, buyers are offered choices under contract terms specifying different forms of delivery.

Since each guarantor is responsible for its open, deliverable positions at the time of expiration, it will be the guarantor's responsibility to guarantee the delivery of compute hours specified in short futures positions open at expiration. As futures approach expiration, a guarantor may require the holder of short futures positions to verify that they can deliver the contracted compute hours. If they cannot, such short positions can be liquidated to ensure market stability and integrity.

Verification of compute delivery can be automatically ensured using verification protocols similar to those implemented by Truebit. Truebit technology works by having a verifier challenge the computations performed by a solver. If a solver's computation is challenged and found incorrect, the solver is penalized, ensuring the integrity and correctness of the computations. This mechanism not only ensures that the computation was performed but also verifies its accuracy without the need for all nodes in the network to redo the work. This approach significantly increases the efficiency and scalability of blockchain-based compute platforms.

In addition to verifying that compute tasks were correctly performed, it is also crucial to verify the capacity and availability of compute resources. This means ensuring that the source of compute is indeed available and capable of performing the required tasks. Verification of capacity can be achieved through regular audits and performance checks integrated into the smart contracts. These checks ensure that providers have the necessary resources available and are not oversubscribing their compute capacity. This dual verification process of both compute and capacity enhances the reliability and trustworthiness of the GCX platform.

Over time, in an embodiment, the GCX platform becomes sovereign chain or rollup, using GCX tokens as the underlying/core token. This would further enhance the platform's efficiency, scalability, and security, providing a robust foundation for global compute trading.

The GCX provides a versatile platform that caters to various stakeholders in the compute market, enabling them to hedge against price volatility, secure future prices, and generate additional yield. As illustrated in the accompanying figures, the GCX platform allows different actors to leverage its functionalities to their advantage.

Alice, an AI startup founder, uses futures contracts to lock in the price of compute, safe-guarding against future price increases. Bob, anticipating a market correction, buys put options to secure a price ceiling, thereby minimizing potential losses. Carol, a data center operator, sells both call and put options to collect premiums, generating additional yield. By utilizing the GCX, these actors can effectively manage their risks and optimize their financial strategies in the dynamic compute market.

In all cases, the GCX enables various expressions of market sentiment, allowing participants to profit and protect against the evolution of compute prices, whether they anticipate an increase, decrease, or sideways movement. This flexibility ensures that the GCX can benefit a diverse range of market participants, each with their unique perspectives and strategies.

Contracts between buyers and sellers in a marketplace for computational resources need to be detailed and comprehensive to ensure fairness and stability. Quality specifications should include parameters such as CPU/GPU speed, RAM, and storage capacity. Pricing terms must reflect current market conditions and be adjustable based on supply and demand dynamics. Dispute resolution mechanisms, such as arbitration, should be clearly outlined to handle any conflicts that arise. Leveraging blockchain technology can further enhance contract management by ensuring transparency and immutability. As AI technologies evolve, regulatory frameworks such as the EU AI Act have been developed aiming to ensure ethical and responsible use. These regulations necessitate robust systems for managing and verifying compute resources to ensure compliance.

The implementation of smart contracts on the GCX platform to manage trading contracts for computational resources is advantageous, according to an embodiment. By automating contract execution, ensuring transaction integrity, and providing transparent compliance tracking, smart contracts can offer a robust and efficient framework for trading computational power. This approach not only mitigates risks and lowers operational costs but also aligns with current trends in digital transformation, positioning GCX at the forefront of the computational resource market's evolution.

Smart contracts on a blockchain are designed according to an embodiment, using standardized templates that encapsulate common terms and conditions needed for compute resource trading. By using blockchain, all parties access the same contract versions, eliminating discrepancies and ensuring that transactions are executed based on mutually agreed terms.

Smart contracts can automatically execute transactions based on coded conditions, such as verifying completion and Quality of Service (QoS) adherence before releasing payments. Automation reduces administrative burdens and accelerates processes by eliminating manual steps in contract management and payments.

Every transaction and amendment is recorded on the blockchain, providing a transparent and unchangeable history. Enhanced transparency ensures easy auditability and trust, as all actions are traceable and verifiable.

Smart contracts include, in certain embodiments, provisions for updates or upgrades as market conditions, regulations, or technology evolves. Updates can be managed through decentralized voting among stakeholders to ensure democratic and agreeable changes.

Blockchain's cryptographic nature makes contracts secure from unauthorized alterations. The immutable and transparent nature of blockchain simplifies the resolution of disputes. Incorporating blockchain and smart contracts in managing compute resources significantly enhances efficiency, trust, and adaptability, creating a robust digital trading platform.

The GCX trading platform revolutionizes the way compute hour contracts are traded, providing a seamless, secure, and efficient marketplace for both buyers and sellers. By streamlining the process from request to delivery, we aim to fully ensure that computational resources are utilized effectively, supporting a wide range of industries and applications. Additionally, the GCX's modular approach allows for flexibility and customization, enabling various applications to be built on top of the platform. This means that marketplaces can choose to integrate only specific aspects of the GCX, such as options, futures, perpetual contracts, or any combination thereof. This flexibility ensures that the GCX can meet the diverse needs of different market participants and use cases. In later sections, we seek to illustrate the GCX trading process through detailed examples that encompasses the experiences of both buyers and sellers.

The GCX is designed to accommodate a wide array of compute needs and resource offerings. It integrates advanced matchmaking algorithms with a user-friendly interface to facilitate transactions between buyers and sellers efficiently. The platform supports a variety of contract types, including spot and futures contracts for compute hours, each with customizable terms to suit the specific requirements of users.

Prices for compute hour contracts are determined based on supply and demand dynamics, ensuring fair pricing that reflects current market conditions. All transactions are secured with blockchain technology, providing transparency and integrity to every contract. The platform's algorithms automatically match sellers' offerings with buyers' needs, optimizing resource allocation and utilization.

Example 1: Hedging Strategies for Compute Resource Volatility Let's consider a specific hedging example where Alice wants to mitigate compute resource costs for her startup.

Alice is the founder of an Al-focused startup seeking venture funding. She anticipates needing 500 TFLOP Hours per month starting in six months, with an ongoing need of 1,000 TFLOP Hours per month after six months of training. To mitigate the risk of higher than expected compute costs, Alice can use the GCX platform to hedge against price volatility.

Alice can purchase futures on the GCX marketplace to lock in her expected compute needs. This allows her to: Purchase more or sell excess compute power if her needs change. Roll her existing futures forward or backward to adjust the timing of delivery. Take delivery of the compute hours at the contract price or sell the futures to lock in gains if prices rise.

Alice can use various options strategies to protect against changes in her compute needs: Buy Call options to protect against increased prices for additional compute hours. Buy Put options to protect against needing less compute and falling prices. Use a combination of Call and Put options (Straddle or Strangle) to protect against both upside and downside changes in compute needs.

Alice can reduce her exposure to changing compute prices and requirements. She can focus on her business without worrying about price volatility. Venture capitalists are more comfortable investing due to reduced risk.

As another example, Bob is building new datacenters for his cloud-based compute business. He needs to lock in prices for future compute sales to secure financing and mitigate the risk of falling prices. Bob can sell long-term futures on the GCX marketplace to lock in prices. As contracts near expiration, they can be rolled into shorter-term contracts.

Bob can buy put options on his futures contracts to protect against downside price risk while allowing for upside gains. Bob can confidently build new datacenters knowing he has locked in profitable pricing. Lenders are more likely to finance his venture due to reduced risk.

As mentioned, another advantage for both Alice's and Bob's businesses is that their investors experience reduced price volatility and more predictable financial outcomes, making these ventures more attractive and secure.

As yet another example, Carol owns a large datacenter and is currently profitable based on current compute pricing. A significant cost for Carol to run her datacenter is the cost of power, so she can choose to turn off her datacenter if power costs outweigh the compute revenues. Carol would like to take advantage of the optionality embedded in being able to power up and down her datacenter. She is profitable selling at current compute prices and would like to earn additional yield to generate steady income and smooth out her long-term revenues.

Carol can sell strips of call options, which will generate a cash premium when sold. This strategy is most advantageous when volatility in compute prices is high since option prices are highly correlated with expected volatility in the underlying asset's price. Selling options at times of high volatility will both take advantage of the high premium to generate additional yield, while at the same time reducing the variability in Carol's future cash flows. Carol can sell call options with strikes set to the current futures price of compute, or she can opt to sell options with strikes that are higher than the current price of compute.

The choice of strike price is dependent on the option volatility smile (skew). If the volatility of higher strike call options is greater than the at-the-money strikes, then Carol can take advantage of this condition to gain additional premium by selling these options. This situation can develop when there is high uncertainty in the markets and fear of prices spiking higher. If the volatility of higher strike call options is lower than the at-the-money strikes, then Carol may wish to sell call options closer to at-the-money. This is the typical situation in many markets due to the natural tendency of producers to hedge.

To provide additional yield, Carol can take on a riskier position by selling puts in addition to calls. This strategy would be more advantageous in a market where option put prices are trading at a significant volatility premium relative to call prices, often the case in a producer-hedger dominated market in times of lower volatility. By selling puts, Carol may be required to purchase compute at a price that, while lower than today's prices, may be significantly lower than the strike price of the put option she sold, thus resulting in significant losses.

However, Carol has the option to turn off her datacenter at these times, so while she will end up losing money on the options if prices drop, she can shut down her own production, putting her in a position as if she were simply unhedged on downside price moves from the start. This strategy carries risks but can be very advantageous when there is a strong put skew in the market. Carol can offset some of this risk by buying an additional put option at a strike below the put option she sold. This will reduce her yield but can return her to a fully hedged position, allowing her to take advantage of yield and smooth out her returns.

Selling puts may result in large losses if the market price of compute drops significantly, effectively losing the optionality of turning off compute and leaving the downside un-hedged.

In summary, the GCX marketplace represents a significant leap forward in the trading of computational resources. By leveraging blockchain technology and smart contracts, we ensure that all transactions are secure, transparent, and efficient. This innovative approach facilitates dynamic and fair pricing but also enhances trust and reliability of the platform. As demonstrated through our detailed example, the GCX platform is poised to support a wide array of compute needs across diverse industries, driving the commodification of compute resources and unlocking new possibilities for growth and innovation.

As another example, Amazon Web Services (AWS) is a leading supplier of cloud computing resources, while we imagine that Citadel, a major hedge fund, engages in financial trading of compute resources on the Global Compute Exchange (GCX). Citadel makes strategic bets on the future direction of compute prices, requiring large quantities of compute resources to support its trading activities. To facilitate these trades, Citadel purchases substantial compute resources from AWS.

AWS provides a vast array of compute resources on the GCX platform. Citadel, operating as a financial trader, needs to acquire large quantities of these resources to execute its trading strategies. By leveraging the GCX, Citadel can efficiently buy and sell compute resources, similar to how it would trade commodities like oil.

Citadel can enter into long-term contracts with AWS on the GCX platform. This allows Citadel to: Secure compute resources at a fixed price, protecting against future price increases and enabling predictable financial planning. Ensure a consistent supply of compute resources, essential for maintaining trading volumes and liquidity in the compute market.

Citadel can also utilize the spot market on the GCX platform to buy compute resources from AWS as needed. This strategy offers: Flexibility to purchase compute power based on real-time demand, potentially benefiting from lower prices during periods of low demand. The ability to dynamically adjust resource levels to align with market conditions and trading activity.

GCX provides a transparent and efficient marketplace for trading compute resources, ensuring fair pricing and reliable transactions. Long-term contracts with AWS offer Citadel price stability and secure supply, crucial for executing large trades. The spot market allows Citadel to optimize costs by purchasing compute resources at favorable prices during “compute off-peak” times.

Through the GCX, Citadel can efficiently manage its compute resource portfolio by purchasing in bulk from AWS and leveraging these resources for financial trades. This enables Citadel to place large bets on the future direction of compute prices, providing liquidity and depth to the market. The use of smart contracts ensures that transactions are executed automatically and transparently, with clearly defined terms and conditions.

Both AWS and Citadel benefit from the security and compliance features embedded in the GCX platform. Smart contracts ensure that all transactions are secure, transparent, and auditable, meeting regulatory requirements and protecting sensitive data.

By leveraging the Global Compute Exchange, AWS can supply compute resources to Citadel, enabling high-volume financial trading and liquidity in the compute market. GCX provides a robust and flexible platform for managing compute resource transactions, offering stability, flexibility, and security in the dynamic compute market.

As a further example, AI modeling startup Nearest helps wealth managers better track portfolios, identify trends, and mitigate risks using sophisticated analytics on historical timeseries data. However, the small data science team struggled with long lead times for accessing GPU servers for model training experiments on Azure, costing tens of thousands of dollars despite modest needs. By leveraging the GCX compute application's (built on top of the GCX exchange platform) auto-scaling pools with cloud credits, they could run iterations much faster without the hassles of managing underlying infrastructure.

Nearest, an AI-focused fintech startup, requires significant computational resources for running complex financial models. Traditional cloud services like Azure were proving too costly and time-consuming, impeding their ability to innovate and deliver timely insights to clients. Nearest can speed up their model training processes, delivering insights to clients faster, reduce infrastructure management burden which allows the team to focus on enhancing their analytics capabilities, and enjoy cost savings from cloud credits and dynamic scaling improve financial efficiency and flexibility.

In another example, animation studio Pixar needed on-demand rendering capacity for a new animation film without major upfront capital costs before release. By leveraging the GCX platform, which links low-priority capacity across render farms, Pixar saved 30% in costs with a faster turnaround for the CGI-heavy project by paying only for the exact hours consumed. The auto-scaled capacity also reduced risks of output delays or resource saturation issues.

Pixar, a leader in animation production, requires extensive computational resources for rendering high-quality animation films. Traditional methods involving significant upfront capital investments in rendering farms were not feasible for the tight production timelines and budget constraints of their new project. Pixar can use the GCX marketplace to access low-priority capacity across render farms. This allows them to utilize idle compute resources for rendering tasks, significantly reducing costs, scale resources dynamically to meet the demands of the project, ensuring timely completion, and pay only for the exact hours consumed, optimizing their budget and avoiding unnecessary expenditures.

Pixar achieves significant cost savings by utilizing low-priority capacity and paying only for consumed resources. The auto-scaling feature ensures timely project completion, maintaining high-quality output. Reduced infrastructure management allows Pixar to allocate more resources to creative development.

We have introduced the Global Compute Exchange (GCX) platform, a groundbreaking solution for the commodification and efficient trading of computational resources. By standardizing compute units through Compute Hours (CH) we have created a robust framework that ensures fair, transparent, and efficient trading. This approach allows for a seamless comparison and utilization of diverse computing resources, much like the established practices in electricity markets.

We have demonstrated the viability of blockchain technology and smart contracts in managing these trades, providing unparalleled security, transparency, and automation. The GCX platform's innovative use of dynamic pricing, secure transactions, and automated matchmaking sets a new standard for the industry, addressing the evolving needs of both buyers and sellers.

Our exploration of the compute pool model highlighted the benefits of aggregating resources to diversify and stabilize supply, ensuring reliable delivery and optimized resource allocation. By enabling participants to stake tokens and leverage decentralized governance, we foster a resilient and trustworthy marketplace.

Furthermore, we provided real-world examples of blockchain applications in various sectors, underscoring the practicality and growing acceptance of this technology. The GCX platform, with its advanced features and user-centric design, is well-positioned to support a wide array of compute needs, driving innovation and efficiency across industries.

In conclusion, the GCX platform not only addresses the current challenges in the computational resource market but also paves the way for future advancements. By creating a transparent, secure, and efficient marketplace, we are unlocking new possibilities for growth and innovation, ensuring that computational resources are accessible, reliable, and optimally utilized. The GCX platform is more than just a trading venue; it is a catalyst for the digital economy, fostering collaboration and driving technological progress.

A glossary of terms is provided:

CPU (Central Processing Unit): The primary component of a computer that performs most of the processing inside a computer. It executes instructions from programs, performing basic arithmetic, logic, control, and input/output (I/O) operations. CPUs are characterized by their versatility and are designed to handle a wide variety of tasks in computing systems.

GPU (Graphics Processing Unit): A specialized processor designed to accelerate graphics rendering. GPUs can process many parallel tasks more efficiently than CPUs, making them ideal for handling complex computations in graphics rendering, machine learning, and scientific simulations. They are particularly known for their ability to perform floating-point calculations required in rendering 3D graphics and AI.

GPGPU (General-Purpose computing on Graphics Processing Units): GPGPU is the utilization of a GPU, which is typically used for rendering graphics, to perform computation traditionally handled by the CPU. This technique leverages the parallel processing capabilities of GPUs to accelerate a wide range of applications beyond graphics, including scientific simulations, machine learning, data analysis, and more.

AI (Artificial Intelligence): The simulation of human intelligence processes by machines, especially computer systems. AI involves the development of algorithms and software to perform tasks that typically require human intelligence, such as visual perception, speech recognition, decision-making, and language translation. Key areas of AI include machine learning, where systems learn and improve from experience, and deep learning, which involves neural networks with many layers.

Compute Hour (CH): A unit of measure representing the computational effort equivalent to one hour of processing on a reference system with a specified performance, typically measured in teraFLOPS (trillions of floating-point operations per second). Example: If a system performs 2 teraFLOPS, it will generate 2 Compute Hours per hour of operation.

Epochs: An epoch refers to one complete pass through the entire training dataset. During each epoch, the model is trained on all the training data once. Training typically involves multiple epochs, and the number of epochs is a crucial hyperparameter that impacts the model's learning and generalization abilities. Too few epochs can lead to underfitting, where the model does not learn adequately from the training data, while too many epochs can cause overfitting, where the model learns noise and performs poorly on new data.

Batch Size: The batch size is the number of training samples processed before the model's internal parameters are updated. Smaller batch sizes can make training noisier but help models generalize better, whereas larger batch sizes can make the training process faster but may lead to overfitting. The choice of batch size affects the stability and speed of the training process and is another critical hyperparameter that needs careful tuning.

Iterations: An iteration refers to one update of the model's parameters and is completed once a single batch of data has been processed. The number of iterations per epoch is determined by the size of the dataset divided by the batch size. For instance, if the dataset contains 1,000 samples and the batch size is 100, it will take 10 iterations to complete one epoch.

Smart Contract: Self-executing contracts with the terms of the agreement directly written into code. These contracts automatically enforce and execute the terms when predefined conditions are met, running on a blockchain to ensure transparency and immutability. Example: A smart contract on the GCX platform could automatically transfer payment to a compute provider once the specified compute hours are delivered and verified.

Blockchain: A decentralized digital ledger that records transactions across many computers in such a way that the registered transactions cannot be altered retroactively. This technology ensures transparency, security, and trust in the data recorded. Example: Blockchain technology underpins the GCX platform, ensuring that all transactions are secure and transparent.

Token Staking: The process of locking tokens in a blockchain-based system to support the network's operations, such as transaction validation, and in return, earning rewards. In the context of GCX, operators stake tokens as a commitment to provide computational resources. Example: Operators on GCX stake tokens to join a compute pool, which are slashed if they fail to deliver the promised compute hours.

Decentralized Governance: A governance structure where decision-making is distributed among all stakeholders rather than being centralized in a single entity. This approach often involves voting mechanisms to make decisions on protocol updates, policies, and other governance matters. Example: GCX may use decentralized governance to allow token holders to vote on changes to smart contracts or platform policies.

Compute Pool: An aggregation of computational resources contributed by multiple operators, managed collectively to provide a stable and scalable supply of compute hours. Pools diversify resources to meet varying computational demands. Example: A compute pool on GCX might include resources from different providers, ensuring high availability and performance for complex tasks.

Dynamic Pricing: A pricing strategy where the price of a commodity fluctuates based on real-time supply and demand conditions. In the GCX marketplace, dynamic pricing ensures fair market value for compute hours. Example: The price of compute hours on GCX might increase during peak demand periods and decrease when demand is low.

Predictive Analytics: The use of statistical algorithms and machine learning techniques to analyze historical data and make predictions about future events. In GCX, predictive analytics help anticipate compute resource needs and preempt potential failures. Example: GCX uses predictive analytics to forecast demand for compute hours and ensure resources are allocated efficiently.

FLOP: A FLOP, or Floating Point Operation (and we take TFLOPs to be the plural form, namely, Floating Point Operations), is a measure of computational performance, especially crucial in tasks involving real-number calculations common in AI and machine learning algorithms. It quantifies the number of calculations a system can perform per second, with higher units like teraFLOPS (TFLOPs) representing one trillion FLOPs and petaFLOPS (PFLOPs) representing one quadrillion FLOPs. Supercomputers performing hundreds of petaFLOPs can handle complex simulations and large-scale data analyses. In AI, models requiring extensive computational power, such as deep learning networks, often measure their demands in teraFLOPs or even petaFLOPs, reflecting the immense resources needed for processing and training.

FLOP-Hours: A measure of computational work that represents the number of floating-point operations a system can perform in an hour. It is used to quantify and compare the computational performance of different systems. Example: A system that performs 1 trillion floating-point operations per second (1 TFLOP) over one hour would generate 1 FLOP-Hour.

PetaFLOP (PFLOP) A PetaFLOP is a measure of computational speed, representing one quadrillion (1015) floating-point operations per second (FLOPS). It is used to quantify the performance of supercomputers and other high-performance computing systems. A supercomputer with a peak performance of 1 PetaFLOP can perform 1015 floating-point calculations every second.

Call Option: A financial contract that gives the buyer the right, but not the obligation, to purchase a specified amount of compute resources at a predetermined price within a specified time period. This is used to hedge against or speculate on price increases.

Put Option: A financial contract that gives the buyer the right, but not the obligation, to sell a specified amount of compute resources at a predetermined price within a specified time period. This is used to hedge against or speculate on price decreases.

Futures Contract: A standardized legal agreement to buy or sell compute resources at a predetermined price at a specified time in the future. This allows companies to hedge against price volatility and secure stable compute costs.

Spot Market: A public financial market in which compute resources are traded for immediate delivery. Prices in the spot market are determined by current supply and demand.

Volatility Smile (Skew): A pattern in which options with different strike prices exhibit varying levels of implied volatility. Higher strike prices may have different implied volatilities than at-the-money strikes, affecting the pricing and attractiveness of these options.

Straddle Option: An options strategy involving the purchase of both a call and put option with the same strike price and expiration date. This is used to profit from large price movements in either direction.

Strangle Option: An options strategy involving the purchase of a call and put option with different strike prices but the same expiration date. This is used to profit from large price movements in either direction, with a lower cost than a straddle.

Dynamic Pricing System: A mechanism that adjusts the price of compute resources in real-time based on current market supply and demand conditions, ensuring fair and transparent transactions.

Smart Contract: A self-executing contract with the terms of the agreement directly written into code. Smart contracts automatically execute and enforce agreements when predetermined conditions are met, ensuring transparency and reducing the need for intermediaries.

Decentralized Task Queue: A system that allows users to submit compute tasks to a distributed network, where tasks are dynamically allocated to available resources based on a consensus mechanism.

Resource Matching Queue: A decentralized system that matches and allocates compute resources to tasks based on real-time demand and resource availability, optimizing resource utilization.

Hedging: The practice of making financial investments to reduce the risk of adverse price movements in an asset. In the context of compute resources, hedging involves using financial instruments like futures and options to manage price volatility.

Yield Generation: The process of earning returns on an investment. In the context of compute resources, this involves strategies like selling options to generate additional income and stabilize revenue streams.

Embedded Optionality: The inherent flexibility in an asset or operation that allows the owner to make strategic decisions based on changing conditions. For example, the ability to power up or down a datacenter in response to power costs and compute revenues.

Carbon Footprint: The total amount of greenhouse gases produced directly or indirectly by human activities. In the context of compute resources, managing and reducing the carbon footprint is crucial for sustainability.

Compute as a Commodity (CaaC): A paradigm that treats computing power as a commodity, similar to utilities like electricity and water. CaaC allows organizations to access vast compute resources on-demand and pay only for what they use, without the need for significant upfront investments. This model leverages the scalability and flexibility of cloud computing, enabling businesses to innovate more rapidly and efficiently by aggregating underutilized capacity across multiple providers and geographies.

Compute as a Service (CaaS): A cloud computing model that provides computing resources as a service over the internet. CaaS allows businesses to rent processing power, storage, and networking infrastructure on a pay-as-you-go basis. This model simplifies the deployment and management of IT resources, offering scalability, cost efficiency, and flexibility. Organizations can quickly scale their infrastructure to meet changing demands without the need for substantial capital investments in physical hardware.

Infrastructure as a Service (IaaS): A cloud computing model that provides virtualized computing resources over the internet. IaaS offers fundamental IT resources such as virtual machines, storage, and networking on a pay-as-you-go basis. It allows businesses to rent and manage these resources without having to purchase and maintain physical hardware. IaaS is highly scalable and flexible, enabling organizations to dynamically adjust their infrastructure to meet changing demands. Examples of IaaS providers include Amazon Web Services (AWS), Microsoft Azure, and Google Cloud Platform (GCP).

Platform as a Service (PaaS): A cloud computing model that provides a platform allowing customers to develop, run, and manage applications without dealing with the underlying infrastructure. PaaS offers a complete development and deployment environment, including tools, libraries, services, and infrastructure, to support the entire application lifecycle. This model abstracts much of the complexity of building and maintaining the underlying hardware and software layers, allowing developers to focus on coding and innovation. Examples of PaaS providers include Google App Engine, Microsoft Azure App Services, and Heroku.

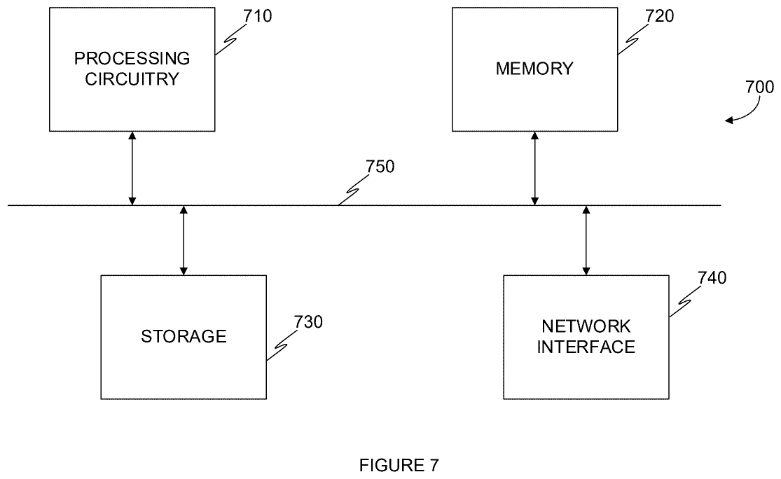

FIG. 7 is an example schematic diagram of a global compute exchange (GCX) system 700 according to an embodiment. The GCX system 700 includes, according to an embodiment, a processing circuitry 710 coupled to a memory 720, a storage 730, and a network interface 740. In an embodiment, the components of the GCX system 700 are communicatively connected via a bus 750.

In certain embodiments, the processing circuitry 710 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 720 is a volatile memory (e.g., random access memory, etc.), a non-volatile memory (e.g., read only memory, flash memory, etc.), a combination thereof, and the like. In some embodiments, the memory 720 is an on-chip memory, an off-chip memory, a combination thereof, and the like. In certain embodiments, the memory 720 is a scratch-pad memory for the processing circuitry 710.

In one configuration, software for implementing one or more embodiments disclosed herein is stored in the storage 730, in the memory 720, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 710, cause the processing circuitry 710 to perform the various processes described herein, in accordance with an embodiment.

In some embodiments, the storage 730 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 740 is configured to provide the GCX system 700 with communication with, for example, a compute resource provider 210, according to an embodiment.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for provisioning abstracted compute resources from cloud computing environments, comprising:
detecting in a cloud computing environment a plurality of compute resources, each compute resource based on a processing circuitry and including a resource type;
applying a benchmark test to each resource type to generate a benchmark result;
determining for each resource type an abstracted compute value based on the benchmark result;
receiving a request to provision a compute resource, the request including a value of abstracted compute; and
provisioning the compute resource based on the received request.

2. The method of claim 1, further comprising:
periodically receiving requests to provision compute resources;
determining for each received request a value of abstracted compute; and
provisioning a compute resource based on each determined value of abstracted compute.

3. The method of claim 1, further comprising:
determining a risk factor associated with the request; and
modifying the value of abstracted compute based on the determined risk factor.

4. The method of claim 3, further comprising:
denying the request to provision compute resources based on the risk factor exceeding a predetermined value.

5. The method of claim 1, further comprising:
generating a resource pool of abstracted compute, wherein the resource pool includes a plurality of identifiers, each identifier correspond to a provisionable resource.

6. The method of claim 1, further comprising:
generating a transaction based on the received request; and
storing the generated transaction as a record on a blockchain.

7. The method of claim 1, further comprising:
generating a new benchmark test;
applying the new benchmark test to each resource to generate a new benchmark result;
determining for each resource type a new abstracted compute value based on the new benchmark result; and
provisioning the compute resource based on the new benchmark result.

8. A method for decreasing allocation risk of abstracted compute resources, comprising:
receiving a request from a client device to allocate compute resources based on a standardized compute framework;
applying a risk assessment on the request to generate a risk score;
detecting a plurality of provisionable compute resources of a compute provider corresponding to the received request;
generating a smart contract on a blockchain between the client device and the compute provider, in response to determining that the generated risk score is below a predetermined threshold value; and
executing the smart contract by allocating the provisionable compute resources to the client device.

9. The method of claim 8, further comprising:
receiving from each compute provider of a plurality of compute providers an allocation of compute resources to a resource pool;
executing the smart contract by allocating at least a portion of the compute resource from the resource pool in response to detecting that the compute provider has not provisioned the provisionable compute resources.

10. A non-transitory computer-readable medium storing a set of instructions for provisioning abstracted compute resources from cloud computing environments, the set of instructions comprising:
one or more instructions that, when executed by one or more processing circuitries of a device, cause the device to:
detect in a cloud computing environment a plurality of compute resources, each compute resource based on a processing circuitry and including a resource type;
apply a benchmark test to each resource type to generate a benchmark result;
determine for each resource type an abstracted compute value based on the benchmark result;
receive a request to provision a compute resource, the request including a value of abstracted compute; and
provision the compute resource based on the received request.

11. A system for provisioning abstracted compute resources from cloud computing environments comprising:
a processing circuitry;
a memory, the memory containing instructions that, when executed by the processing circuitry, configure the system to:
detect in a cloud computing environment a plurality of compute resources, each compute resource based on a processing circuitry and including a resource type;
apply a benchmark test to each resource type to generate a benchmark result;
determine for each resource type an abstracted compute value based on the benchmark result;
receive a request to provision a compute resource, the request including a value of abstracted compute; and
provision the compute resource based on the received request.

12. The system of claim 11, wherein the memory contains further instructions which when executed by the processing circuitry further configure the system to:
periodically receive requests to provision compute resources;
determine for each received request a value of abstracted compute; and
provision a compute resource based on each determined value of abstracted compute.

13. The system of claim 11, wherein the memory contains further instructions which when executed by the processing circuitry further configure the system to:
determine a risk factor associated with the request; and
modify the value of abstracted compute based on the determined risk factor.

14. The system of claim 13, wherein the memory contains further instructions which when executed by the processing circuitry further configure the system to:
deny the request to provision compute resources based on the risk factor exceeding a predetermined value.

15. The system of claim 11, wherein the memory contains further instructions which when executed by the processing circuitry further configure the system to:
generate a resource pool of abstracted compute, wherein the resource pool includes a plurality of identifiers, each identifier correspond to a provisionable resource.

16. The system of claim 11, wherein the memory contains further instructions which when executed by the processing circuitry further configure the system to:
generate a transaction based on the received request; and
store the generated transaction as a record on a blockchain.

17. The system of claim 11, wherein the memory contains further instructions which when executed by the processing circuitry further configure the system to:
generate a new benchmark test;
apply the new benchmark test to each resource to generate a new benchmark result;
determine for each resource type a new abstracted compute value based on the new benchmark result; and
provision the compute resource based on the new benchmark result.

18. A system for decreasing allocation risk of abstracted compute resources comprising:
a processing circuitry;
a memory, the memory containing instructions that, when executed by the processing circuitry, configure the system to:
receive a request from a client device to allocate compute resources based on a standardized compute framework;
apply a risk assessment on the request to generate a risk score;
detect a plurality of provisionable compute resources of a compute provider corresponding to the received request;
generate a smart contract on a blockchain between the client device and the compute provider, in response to determining that the generated risk score is below a predetermined threshold value; and
execute the smart contract by allocating the provisionable compute resources to the client device.

19. The system of claim 18, wherein the memory contains further instructions which when executed by the processing circuitry further configure the system to:
receive from each compute provider of a plurality of compute providers an allocation of compute resources to a resource pool; and
execute the smart contract by allocating at least a portion of the compute resource from the resource pool in response to detecting that the compute provider has not provisioned the provisionable compute resources.
